(19) United States
(12) Patent Application Publication
(10) Pub. No.: US 2012/0150754 A1
(43) Pub. Date: Jun. 14, 2012

(54) Lifecycle impact indicators

(75) Inventors: Christian L. Belady, Mercer Island, WA (US); Rob Bernard, Redmond, WA (US); Angel Sarmento Calvo, Redmond, WA (US); Larry Cochrane, Redmond, WA (US); Jason Garms, Redmond, WA (US); Roderick A. Hyde, Redmond, WA (US); Royce A. Levien, Lexington, MA (US); Robert W. Lord, Seattle, WA (US); Richard T. Lord, Tacoma, WA (US); Mark A. Malamud, Seattle, WA (US); Jennifer Mame Pollard, Redmond, WA (US); John D. Rinaldo, JR., Bellevue, WA (US); Clarence T. Tegreene, Bellevue, WA (US); Rene A. Vega, Scotts Valley, CA (US); Lowell L. Wood, JR., Bellevue, WA (US); Feng Zhao, Bellevue, WA (US)

(73) Assignee: Searete LLC, Bellevue, WA (US)

(21) Appl. No.: 12/928,638

(22) Filed: Dec. 14, 2010

(51) Int. Cl. G06Q 10/00

(52) U.S. Cl. 705/308

(57) ABSTRACT

A system includes, but is not limited to, a physical product associated with a device-readable indicator, the device-readable indicator associated with a first potential-ecological-impact quantification and with a first-disposal-mode identifier describing a first mode of disposing of at least a first portion of the physical product. In addition to the foregoing, other aspects are described in the claims, drawings, and text forming a part of the present disclosure.

### SUMMARY

A physical device includes, but is not limited to a physical product associated with a device-readable indicator, the device-readable indicator associated with a first potential-ecological-impact quantification and with a first-disposal-mode identifier describing a first mode of disposing of at least a first portion of the physical product. In addition to the foregoing, other system aspects are described in the claims, drawings, and text forming a part of the present disclosure.

A computer implemented method includes, but is not limited to receiving a device-readable indicator associated with at least a first portion of a physical product, the device-readable indicator associated with a first potential-ecological-impact quantification and a first-disposal mode identifier describing a first mode of disposing of at least the first portion of the physical product; and displaying information that is at least based on the first potential-ecological-impact quantification. In addition to the foregoing, other method aspects are described in the claims, drawings, and text forming a part of the present disclosure.

In one or more various aspects, related systems include but are not limited to circuitry and/or programming for effecting the herein-referenced aspects; the circuitry and/or programming can be virtually any combination of hardware, software, and/or firmware configured to effect the herein-referenced method aspects depending upon the design choices of the system designer.

A computer-readable storage medium product includes, but is not limited to instructions for receiving a device-readable indicator associated with at least a first portion of a physical product, the device-readable indicator associated with a first potential-ecological-impact quantification and a first-disposal mode identifier describing a first mode of disposing of at least the first portion of the physical product; and instructions for displaying information that is at least based on the first potential-ecological-impact quantification. In addition to the foregoing, other computer-readable storage medium aspects are described in the claims, drawings, and text forming a part of the present disclosure.

A system includes, but is not limited to means for receiving a device-readable indicator associated with at least a first portion of a physical product, the device-readable indicator associated with a first potential-ecological-impact quantification and a first-disposal mode identifier describing a first mode of disposing of at least the first portion of the physical product; and means for displaying information that is at least based on the first potential-ecological-impact quantification. In addition to the foregoing, other system aspects are described in the claims, drawings, and text forming a part of the present disclosure.

A computer implemented method includes, but is not limited to associating a physical product with a user account in response to receiving a device-readable indicator for the physical product; and adjusting an ecological-impact score associated with the user account based on a potential-ecological-impact quantification associated with the physical product. In addition to the foregoing, other method aspects are described in the claims, drawings, and text forming a part of the present disclosure.

In one or more various aspects, related systems include but are not limited to circuitry and/or programming for effecting the herein-referenced aspects; the circuitry and/or programming can be virtually any combination of hardware, software, and/or firmware configured to effect the herein-referenced method aspects depending upon the design choices of the system designer.

A system includes, but is not limited to circuitry for associating a physical product with a user account in response to receiving a device-readable indicator for the physical product; and circuitry for adjusting an ecological-impact score associated with the user account based on a potential-ecological-impact quantification associated with the physical product. In addition to the foregoing, other system aspects are described in the claims, drawings, and text forming a part of the present disclosure.

A system includes, but is not limited to means for associating a physical product with a user account in response to receiving a device-readable indicator for the physical product; and means for adjusting an ecological-impact score associated with the user account based on a potential-ecological-impact quantification associated with the physical product. In addition to the foregoing, other system aspects are described in the claims, drawings, and text forming a part of the present disclosure.

A computer-readable storage medium product includes, but is not limited to instructions for associating a physical product with a user account in response to receiving a device-readable indicator for the physical product; and instructions for adjusting an ecological-impact score associated with the user account based on a potential-ecological-impact quantification associated with the physical product. In addition to the foregoing, other computer-readable storage medium aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 shows a high-level illustration of an operational environment.

FIG. 2 shows an exemplary high-level illustration of an exemplary system.

FIG. 3 shows a high-level illustration of an operational environment.

FIG. 4 shows an operational procedure.

FIG. 5A shows an alternative embodiment of the operational procedure of FIG. 4.

FIG. 5B shows an alternative embodiment of the operational procedure of FIG. 4.

FIG. 6 shows an alternative embodiment of the operational procedure of FIG. 5A.

FIG. 7 shows an alternative embodiment of the operational procedure of FIG. 6.

FIG. 8 shows an alternative embodiment of the operational procedure of FIG. 5B.

FIG. 9A shows an alternative embodiment of the operational procedure of FIG. 5B.

FIG. 9B shows an alternative embodiment of the operational procedure of FIG. 5B.

FIG. 9C shows an alternative embodiment of the operational procedure of FIG. 5B.

FIG. 10 shows an alternative embodiment of the operational procedure of FIG. 9B.

FIG. 11A shows an alternative embodiment of the operational procedure of FIG. 5B.

FIG. 11B shows an alternative embodiment of the operational procedure of FIG. 5B.

FIG. 12 shows an alternative embodiment of the operational procedure of FIG. 11A.

FIG. 13 shows an alternative embodiment of the operational procedure of FIG. 11A.

FIG. 14 shows an alternative embodiment of the operational procedure of FIG. 6.

FIG. 15 shows an alternative embodiment of the operational procedure of FIG. 14.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The consumption of rare materials and the ecological impact caused by human behavior are both becoming serious problems for the Earth. For example, some experts estimate that our use of the ecosystem to obtain food, timber, energy, exceeds the planet's ability to provide. As if the scarcity of resources was not enough of a problem, human behavior is also causing increasing amounts of greenhouse gasses to be emitted into the atmosphere. Certain greenhouse gasses, such as carbon monoxide, sulfur dioxide, chlorofluorocarbons (CFCs) and nitrogen oxides, are generated by manufacturing, using, and disposing of products and the general consensus is that these greenhouse gases cause harm to the environment. For example, according to the 2007 Fourth Assessment Report by the Intergovernmental Panel on Climate Change (IPCC), greenhouse gases have caused the global surface temperature increased 0.74±0.18 C (1.33±0.32 F) during the 20th century. Climate models project that the temperature will increase another 1.1 to 6.4 C (2.0 to 11.5 F) during the 21st century. It is likely that this increase in temperature is a significant problem for living creatures. For example, the living planet index, which is an indicator of the state of global biological diversity, shows that between the period of 1970 and 2003 biodiversity fell 30 percent.

While the demand for products is causing significant damage to the environment, most people are complacent. People generally indicate that they care about the environment; however, people typically do not act in an environment friendly way because they are not aware of how their actions truly affect the environment. On reason for this may be that impact is too abstract to appreciate. For example, a person may recognize that driving a car causes harm to the environment; however, the person may not appreciate how much harm it causes because the person does not have to face any immediate penalty for driving nor does the person have to perceive any recognizable link between their behavior and the damage caused.

Accordingly, robust methods, systems, and computer program products are provided to, among other things, bring about an operational system wherein users can perceive how consumption behavior affects the environment. In an exemplary embodiment, potential ecological impact associated with products can be quantizied, e.g., mapped to a discrete set of numbers (−99 to 99), or mapped to an abstract scale, e.g., “awful,” “bad,” “neutral,” “good,” and “exceptional” to express the impact these products have had and/or will have on the environment. Potential-ecological-impact quantifications can be calculated for one or more stages of a product's lifecycle and/or for one or more disposal modes for the product. In at least one example embodiment, a user can perceive the potential-ecological-impact quantifications for a product (or information based at least in part on the quantifications) and understand how much estimated harm the product has caused to the environment (e.g., from the mere fact that it was created) and/or how much harm the product can potentially cause when it is disposed of. The potential-ecological-impact quantifications allow the user to make a determination as to whether he or she wants to use products that are harmful to the environment and/or how to dispose of products he or she owns.

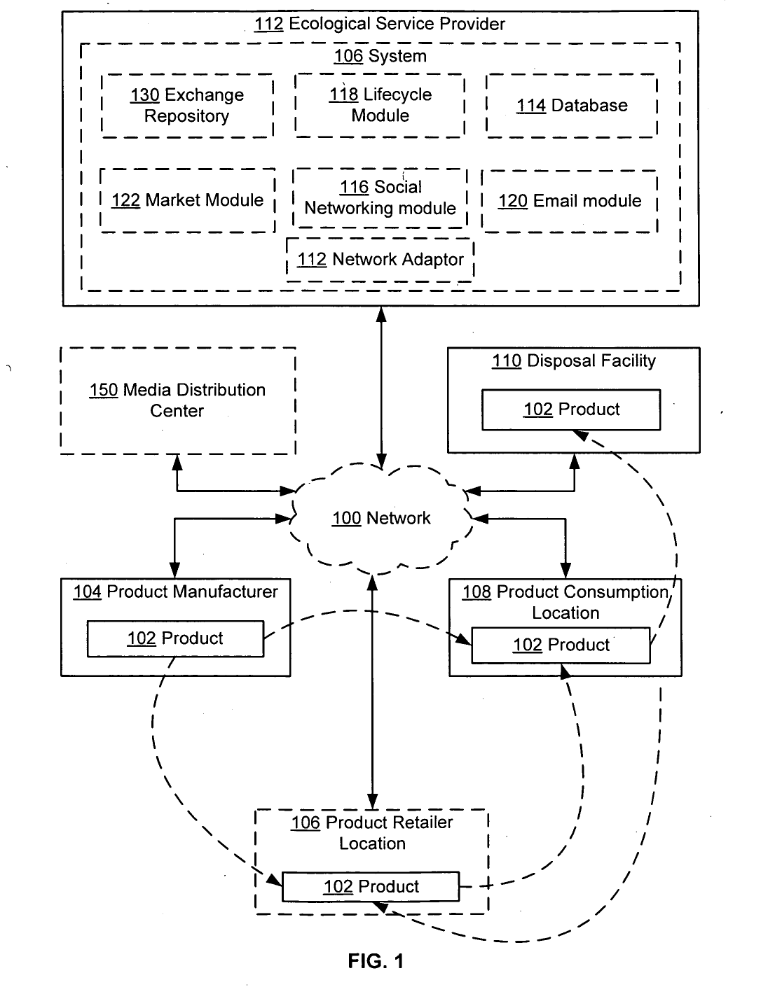

Referring now to FIG. 1, it illustrates a high-level block diagram of an exemplary operational environment that can be used to describe embodiments of the present disclosure. The arrows in dashed lines illustrate how product 102 can move through different locations throughout its life. The block-elements indicated in dashed lines are indicative of the fact that they are considered optional.

As an aside, each location within FIG. 1 can be interconnected via network 100, which may be the Internet. Each location can connect to network 100 using an access method such as, for example, a local area network (LAN), a wireless local area network (WLAN), personal area network (PAN), Worldwide Interoperability for Microwave Access (WiMAX), public switched telephone network (PTSN), general packet radio service (GPRS), cellular networks, and/or other types of wireless or wired networks.

FIG. 1 illustrates various points in the lifecycle of product 102, e.g., an appliance, vehicle, electronic device, food-services item, etc. At some point in time, product 102 can be manufactured by product manufacturer 104. For example, a company can purchase raw materials and/or manufactured materials and create product 102. After product 102 is manufactured, it can be optionally transported to product retailer 106 to be sold to a user (or sold directly to a user) and transported to product consumption location 108, e.g., a user's home. The user can use the product, resell product 102 to product retailer 106 (or another product retailer), donate product 102 (not shown), or sell product 102 to another user (not shown). Eventually, product 102 will be fully consumed, i.e., used up, broken, etc., and can be disposed of. Product 102 can be transported to a disposal facility 110, e.g., landfill, recycling facility, incineration facility, etc., where it can be disposed of.

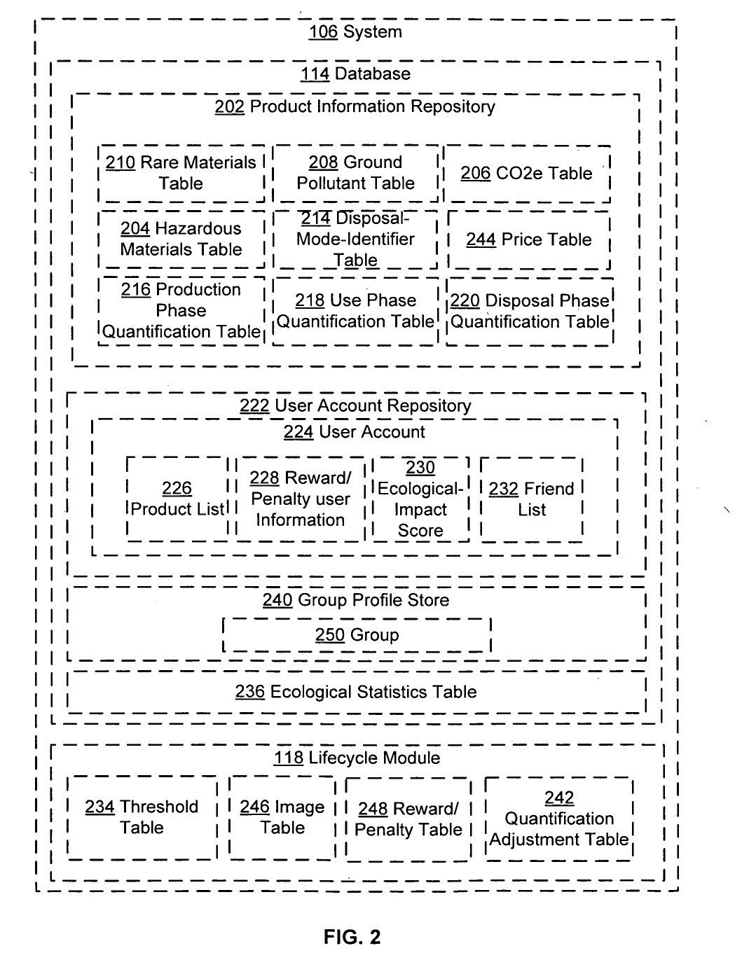

In an exemplary embodiment, ecological service provider 112 can be used generate potential-ecological impact quantifications and communicate them (or information based on them) to users at different points in the lifecycle of product 102. For example, ecological service provider 112 can include system 106, which can include one or more computer systems having processors, memory, operating system software, network adaptors, etc. As shown by the figure, system 106 can include database 114, which is described in more detail in FIG. 2 and the following paragraphs. Also shown by the figure is market module 122, which can store market data in exchange repository 130. Briefly, market module 122 can be configured to effect an online market place for the exchange of products. For example, market module 122 can generate one or more web-pages that can be sent to computing devices, e.g., computer systems, mobile phones, etc., that can be used to search for products, list products for exchange, and/or register for notifications for products. The lists of products for sale, offers for products, etc., can be stored in exchange repository 130, which can be effected by one or more databases.

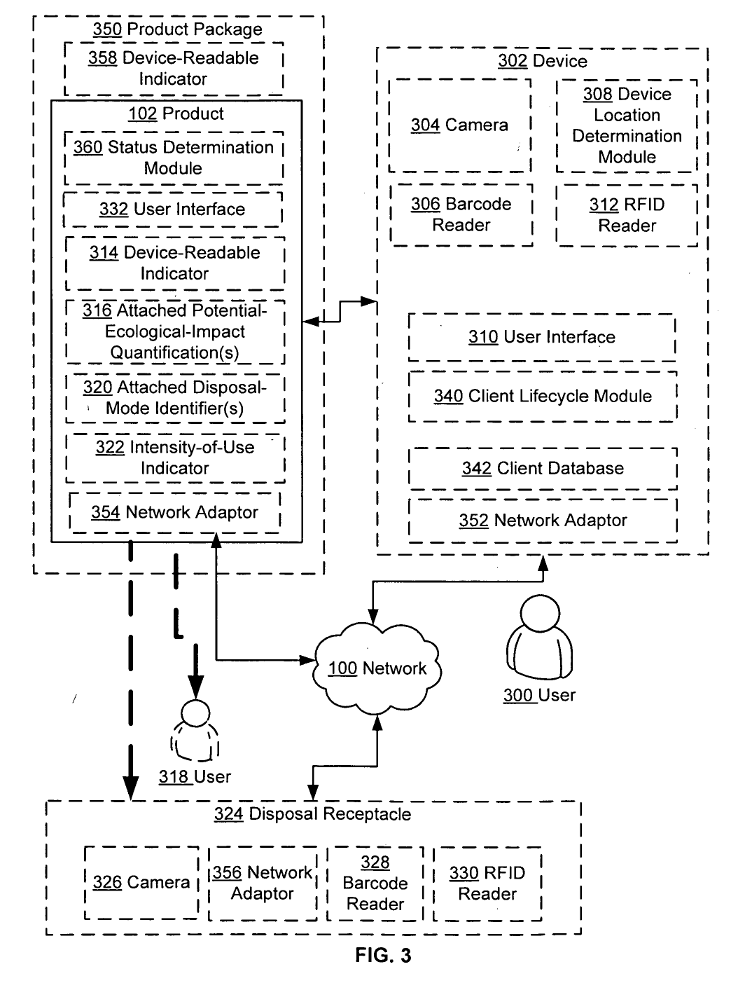

Continuing with the high-level overview of FIG. 1, system 106 can include social networking module 116 and/or email server 120. Briefly, social networking module 116 can be configured to generate one or more web-pages that can be sent to computing devices such as device 302 of FIG. 3, which is described in more detail in the following paragraphs. In an exemplary embodiment, the web-pages can allow users to create and manage user profiles and/or interact with other users that have created profiles. In the same, or another exemplary embodiment, the web-pages can be used to interface with a lifecycle module, which is described in more detail in the following paragraphs. Also shown is email module 120, which can effect an email system that can send emails to computing devices such as device 302 of FIG. 3. In an exemplary embodiment, the emails can contain various information such as offers to purchase products, rewards, potential-ecological-impact quantifications (described in more detail in the following paragraphs), etc.

Media distribution center 150 is also illustrated in FIG. 1. Media distribution center 150 can be maintained by the same organization that maintains server 106 or a separate entity. Generally, media distribution center 150 can be configured to receive; store; and/or disseminate information gathered by system 106. For example, media distribution center 150 can be configured to include a webserver, email server, short message service (“SMS”) server, television station, etc. In a specific example, media distribution center 150 can receive, store, and/or disseminate information that is at least based in part on ecological-impact scores (which are described in more detail in other paragraphs) for users. For example, media distribution center 150 could be an organization that allows users to create Internet-based journals, e.g., blogs. In this example, the blog could receive the ecological-impact score from, for example, device 302 or system 106. The ecological-impact score could then be stored within a webpage or document that is accessible via the blog.

System 106 also includes lifecycle module 118 (“LCM”) and database 114. As shown by FIG. 2, database 114 can include product information repository 202, which can include information for one or more products and user account repository 222, which can store user accounts for each user of the system. For example, each product can be assigned a device-readable indicator, which could be a unique alphanumeric value, that can be used to identify the product within system 106. Each user account can also be assigned an alphanumeric value that can be used to identify the user account within system 106. Product information repository 202 can store product information for product 102 of FIG. 1 along with information for other products and user account repository 222 can store information for user account 224, which can be a user account for user 300 of FIG. 3. As one of skill in the art can appreciate, the information described as “within” database 114 can be stored in one or more physical databases in one more geographic locations and the disclosure is not limited to the illustrated configuration.

Product information repository 202 can include one or more collections of information gathered by an agent of ecological service provider 112 and/or by an agent of product manufacturer 104. In embodiments of the present disclosure, the collected data can be used to generate potential-ecological-impact quantifications, e.g., values such as 5 impact points or abstract values such as “good,” “average,” or “bad,” for at least one stage of a product's lifecycle, e.g., its production phase, use phase, and/or disposal phase, that can be stored in product information repository 202 in the appropriate section (namely, production phase quantification table 216, use phase quantification information 218, and/or disposal phase quantification information 220, the latter potentially including multiple quantifications for a product: one quantification for each disposal mode for a product.)

One type of data can be gathered and stored in rare materials table 210 is an itemized list of the materials that are used up and/or the materials that that a product is made from when it is manufactured. In at least one exemplary embodiment, data that identifies the rare materials that are in product 102 (and other products) and/or the rare materials that were consumed in the process of making product 102 can be used to generate one or more potential-ecological-impact quantifications. For example, an agent from ecological service provider 112 and/or product manufacturer 104 can obtain a breakdown of the components in product 102 and derive the amount of rare-earth materials and/or rare materials that were used to create product 102.

Rare materials can include rare-earth materials and/or materials that are simply scarce. For example, the International Union of Pure and Applied Chemistry has established a collection of chemical elements from the periodic table that are considered “rare-earths.” For the most part, these elements are not rare in the sense that they are not abundant, but that they are difficult to purify from their oxides. Rare-earth elements are essential components in modern electronics and demand is growing. For example, Cerium oxide, the lowest value rare earth, jumped 930 percent from 2007 to over $35 per kilogram in 2010. The rare-earth elements are Lanthanum (which can be used to create high refractive index glass, camera lenses, battery-electrodes), Cerium, Praseodymium, Neodymium, Promethium (which can be used to create nuclear batteries), Samarium, Europium, Gadolinium (which can be used to create computer memory), Terbium, Dysprosium, Holmium, Erbium (which can be used to produce vanadium steel), Thulium, Ytterbium, Lutetium, Actinium, Thorium, Protactinium, Uranium, Neptunium, Plutonium, Americium, Curium, Berkelium, Californium, Einsteinium, Fermium, Mendelevium, Nobelium, and Lawrencium.

Hazardous materials information for each product can be collected and stored in database 114 in, for example, hazardous materials table 204 and used to create one or more potential-ecological-impact quantification for products such as product 102. Hazardous waste can include waste that poses a substantial or potential threat to public health and/or the environment. The list of hazardous substances tracked and stored in hazardous materials table 204 may vary a bit from one country to another and can include, but is not limited to, substances that may explode when exposed to a flame or when shocked, substances that are highly flammable, etc., and/or substances that are toxic, corrosive, infectious, carcinogenic, etc.

Ground pollutant data can be stored in ground pollutant table 208 and used to create one or more potential-ecological-impact quantifications. Generally, ground pollutant data can include information such as the estimated amount of pollutants that are emitted by product manufacturer 104 (other than hazardous waste) when producing a product and/or the estimated amount of ground pollution generated by disposing of a product according to different disposal modes. In an exemplary embodiment, the ground pollutants tracked can include, but are not limited to, heavy metals, chlorinated hydrocarbons, led, zinc, benzene, etc. This type of typically enters the environment via landfills.

Carbon dioxide equivalent table 206 can include information about the greenhouse gases (i.e., normalized greenhouse gases expressed as carbon dioxide equivalent or CO₂e) that are associated with product 102. Greenhouse gasses are emitted in almost every stage of a product's lifecycle and in an exemplary embodiment, the amount of normalized greenhouse gasses that can be attributed to the production, use, and/or disposal of a product can be collected and used to generate one or more potential-ecological-impact quantifications. For example, an agent from ecological service provider 112 or product manufacturer 104 can measure the amount of electricity used by product manufacturer 104 and determine how much energy is used to manufacturer one product. The source of the energy can be determined from the power plant and the amount of CO₂e emissions generated by the power plant in order to produce the power used to acquire raw materials and manufacture a product can be captured and stored in CO₂e information 206.

The amount of CO₂e generated from power plants can be estimated from information obtained from the energy grid. For example, the power company that manages the grid can provide information that identifies the source of the energy, e.g., hydro-power, natural gas, coal, etc., and the CO₂e emissions with each energy source can be calculated as well as the percentage of energy generated from each source. In this example, the amount of CO₂e emissions that can be tied to the production of the energy needed to create product 102 can be captured and stored in CO₂e table 206.

The list of gasses can include the following and an amount of each gas can be multiplied by a scalar value, shown in parenthesis, in order to convert the gases (in metric tons) to CO₂e: carbon dioxide (1), methane (21), nitrous oxide (310), perfluorocarbons (2,300), hydrofluorocarbons (12,000), sulphur hexafluoride (23,900). This shows that one million metric tons of methane and nitrous oxide is equivalent to emissions of 21 and 310 million metric tons of carbon dioxide. In an exemplary embodiment, information provided from the Environment Protection Agency (the “EPA”) can be used to estimate the amount of CO₂e associated with products. This information can be found in the report entitled “Inventory of U.S. Greenhouse Gas Emissions and Sinks: 1990-2005” and the EPA's report entitled “Solid Waste Management and Greenhouse Gases: A lifecycle Assessment of Emissions and Sinks,” 3^{rd} Edition September 2006, both of which are herein incorporated in their entirety.

In exemplary embodiments, some or all of the above mentioned data can be used to generate one or more potential-ecological-impact quantifications for one or more products. For example, an exemplary potential-ecological-impact quantification could be based at least in part on the amount of rare-materials associated with a product, the amount of hazardous waste associated the product, the amount of ground pollution associated with the product, and/or the amount of CO₂e associated with the product. For example, 60 kilograms of CO₂e may be emitted during the manufacturing process for a cellular phone. In an exemplary embodiment, this amount of CO₂e can be quantized along with the amount of rare materials in the cellular phone, the amount of hazardous waste and ground pollution created to make the cellular phone. The quantifications can then be combined, e.g., added, multiplied, etc., in order to create a potential-ecological-impact quantification.

Each potential-ecological-impact quantification can be categorized into groups for different stages of a product's lifecycle. For example, ecological-impact associated with a production phase can be stored in production phase quantification table 216. The other tables being use phase quantification table 218, and disposal phase quantification table 220. In an exemplary embodiment, a single product may be associated with a potential-ecological-impact quantification that is based on the potential harm to the environment caused by producing the product, a potential-ecological-impact quantification that is based on the potential harm caused by using the product, and potential-ecological-impact quantifications for the potential harm that could be caused by the different ways of disposing of the product. In another exemplary embodiment, a single potential-ecological-impact quantification can be generated that shows the cumulative ecological-impact caused by the product, e.g., the potential-ecological-impact quantification could be the sum of all of the aforementioned potential-ecological-impact quantifications for the different phases of the product's lifecycle.

In a specific example, production potential-ecological-impact quantifications can be based on the amount of rare-materials in a product or the amount of rare-materials that were consumed to create a product. In this example, the quantification process can use the price of the rare-material and/or the amount of the rare-material in product 102 when generating a potential-ecological-impact quantification. For example, a kilogram of a less valuable rare-earth material such as cerium oxide could be mapped to a materials-score of 1 where as a kilogram of praseodymium (a more expensive rare-earth) can be mapped to a potential-ecological-impact quantification of 9. The materials potential-ecological-impact quantification can optionally be combined with other potential-ecological-impact quantifications to create a production potential-ecological-impact quantification.

In addition to rare-materials, a production potential-ecological-impact quantification can be based on the amount and type of hazardous waste that was created to produce a product. For example, a high amount of a dangerous type of hazardous waste can be mapped to a high potential-ecological-impact quantification. This potential-ecological-impact quantification can optionally be combined with other potential-ecological-impact quantifications to create production potential-ecological-impact quantification.

In yet another embodiment, a production potential-ecological-impact quantification can be based on the amount of CO₂e generated to create a product. For example, CO₂e is typically emitted during this phase in order to generate the energy to transport raw/manufactured materials to product manufacturer 104 and the energy needed to assemble the materials into the product. In this example, the amount of CO₂e generated to build one product can be estimated and mapped to a CO₂e-based potential-ecological-impact quantification. For example, low amounts of CO₂e can be mapped to low CO₂e-based potential-ecological-impact quantifications and high amounts of CO₂e can be mapped to high CO₂e-based potential-ecological-impact quantifications. A CO₂e-based potential-ecological-impact quantification can then be combined with one or more other potential-ecological-impact quantifications to obtain a production phase potential-ecological-impact quantifications.

CO₂e emissions associated with acquiring raw materials and manufacturing product 102 can include energy consumed to obtain raw materials, manufacturer products, manage the corporation, and dispose of waste. In general, the majority of energy used for these activities is derived from fossil fuels burned to operate mining equipment, fuel blast furnaces, etc., and to generate electricity to power machines used during the manufacturing stage.

Use phase potential-ecological-impact quantifications can reflect the potential harm caused to the environment due to the transporting, storing, and actually using a product. The majority of the ecological impact in this phase can be attributed to CO₂e emissions associated with the power used by a product, and/or the CO₂e emitted by product as it operates, e.g., a vehicle. Food services products may require refrigeration, which requires electricity that is associated with CO₂e emissions. Most cold storage facilities operate at a wide range of temperatures. In an exemplary embodiment, an average temperature can be estimated along with an average size of a storage facility and the average amount of energy used to refrigerate a product, which may be a six pack of beer. This information along with the volume of the product can be used to estimate the CO₂e emissions caused by storing the product in a refrigerated facility. The CO₂e emissions can be used to generate a use phase potential-ecological-impact quantification, which can be stored in use phase quantification table 218.

Similar to the aforementioned potential-ecological-impact quantification associated with transportation and/or storage, a potential-ecological-impact quantification associated with operating the product can be calculated from mostly the CO₂e emitted in order to generate the power for a product and/or the CO₂e emitted by the product as it is running. This data can be gathered for product 102; stored in CO₂e table 206; and used to generate a CO₂e based use phase potential-ecological-impact quantification. For example, any product that consumes electricity most likely causes harm (even if it is indirect harm) to the environment due to the fact that the power it consumes likely comes from a source of energy that generates CO₂e.

When a user is finished with a product (when it is at the end of its life for example) it can be disposed of. In an exemplary embodiment, disposal phase potential-ecological-impact quantifications can be based on one or more of the amount of rare materials lost due to disposing of a product, the amount of CO₂e emitted when disposing of a product (either from the product or from the equipment used to dispose of the product), the amount of hazardous waste that product emits during disposal, the amount of ground pollution generated by disposing of a product, etc. In an exemplary embodiment, each disposal phase potential-ecological-impact quantification can be associated with a disposal-mode-identifier stored in disposal-mode-identifier table 214. The disposal-mode-identifier can be associated with information that describes how to dispose of the product according to a disposal mode. For example, a recycling disposal-mode-identifier could be associated with text that provides the address of a recycling facility or a map to the recycling facility. In another specific example, an incineration disposal-mode identifier can include audio describing which type of disposal receptacle, e.g., trash can, dumpster, etc., the product should be placed in to have it incinerated.

Since a product can be disposed of in different ways, each product can be associated with multiple disposal potential-ecological-impact quantifications. An exemplary, non-exhaustive list of disposal modes can include reselling (and/or donating, trading, etc), recycling, composting, incinerating, landfilling, etc. Thus, in an exemplary embodiment a product can be associated with one or more potential ecological impact quantification for each disposal mode that is available to a product. For example, a product such as a mp3 player may have available modes that include a reselling mode, a recycling mode, and a landfilling mode.

In an exemplary embodiment, a product can be associated with a resell disposal mode. In this exemplary embodiment, the potential-ecological-impact quantification associated with reselling the product can be based on an estimated amount of CO₂e used to transport the product from one user to the next user. In some instances, the CO₂e may be negligible.

In an exemplary embodiment, a product can be associated with a potential-ecological-impact quantification associated with a recycling disposal mode. In an exemplary embodiment, the potential-ecological-impact quantification for recycling can be based on, for example, the amount of CO₂e associated with generating the power used to disassemble the product, the amount of rare materials that are lost during the recycling process, etc. Since recycling a product involves disassembling the product and using parts of it in other products, products made from a recycled product may have lower production phase potential-ecological-impact quantifications than similar products made from virgin materials.

Composting is another disposal mode and a potential-ecological-impact quantification for composting a product can be generated. Composting is the process of disposing of organic material by way of aerobic decomposition. For example, composing may result in CH₄ emissions from anaerobic decomposition and N₂0 may be released by the soil after compost is applied to the ground, however these emissions are essentially zero. Composing has an additional benefit of capturing carbon and can be used to enrich soils. Disposal by sequestration is another technique used to reduce the amount of carbon that escapes into the environment. The EPA estimates composting/sequestering reduces the amount of CO₂e emitted by 0.05 metric tons of CO₂e per ton of compost. In an exemplary embodiment, the information can be used to generate a composing CO₂e-based potential-ecological-impact quantification for products that can be composted. In some instances, this potential-ecological-impact quantification could reduce the harm caused to the planet.

Another disposal mode is incineration. Incineration involves the combustion of organic substances within waste materials thereby converting the waste into ash, heat, and flue gases, which may contain significant amounts of particulate matter, heavy metals, dioxins, furans, sulfur dioxide, and hydrochloric acid, and/or CO₂. Municipal solid waste (“MSW”) contains approximately the same mass fraction of carbon as CO₂ itself (27%), so incineration of 1 ton of MSW produces approximately 1 ton of CO₂. In an exemplary embodiment, the amount of CO₂e emitted by incineration, the amount of CO₂e generated in order to power the incineration facility, the amount of hazardous waste generated, etc., can be gathered; and used to create a potential ecological impact quantification for disposing of a product according to an incineration mode of disposal. Similar to incineration, waste can evaporated by storing liquids in evapo-transpiration beds or mechanical evaporation units and potential-ecological-impact quantifications can be developed that reflect the harm to the environment caused by evaporating liquid products.

A disposal mode for a product could include sending the product to a landfill. During solid-waste landfill operations, waste collection vehicles transport the waste materials to a tipping face or working front where they unload their load. After loads are deposited, compactors or dozers can be used to spread and compact the waste on the working face and the compacted waste can be covered with soil daily.

Landfills cause a number of problems for the environment such as pollution by the contamination of groundwater and soil and the gasses released by decaying organic material. The CO₂e emissions of a landfill are mostly due to methane emissions, transportation related carbon dioxide emissions, and carbon storage resulting from landfilling organic waste and solid waste. Metals do not contain carbon and do not generate CO₂e emissions, however they could cause ground pollution. For example, salt, nitrates, led, copper, nickel, cadmium, etc., are different materials that can cause ground pollution. Plastics do not biodegrade and therefore do not emit greenhouse gases. This information can then be used to create a landfill potential-ecological-impact quantification.

Ocean floor disposal is another disposal method. This technique involves depositing waste, e.g., radioactive waste, in ocean floor sediment. Exemplary techniques for depositing waste involves encasing the waste in concrete or in a shaft drilled into the bottom of the ocean. Potential-ecological-impact quantifications can be created that take into account the potential-ecological harm caused by depositing waste in the ocean.

In addition to storing potential-ecological-impact quantifications, in an exemplary embodiment, database 114 can also maintain user accounts. The user accounts can be tied into a social network where users can blog, post pictures, send message to each other, etc. Social networking module 116 can be configured to generate one or more web-pages that can be downloaded to computing devices, e.g., table personal-computers, smart phones, etc., that include logic operable to allow users to interact with each other. For example, social networking module 116 can send web-pages to computing devices that allow users to blog, post pictures, etc. User account 224 is illustrated, which can be associated with user 300 (while one user account is shown, system 106 can maintain accounts for a plurality of users).

In addition to the foregoing, each user account, such as user account 224 can include a product list 226, which can contain a listing of products associated with user account 224. For example, product list 226 can be a running list of products that have been associated with user account. Each product the user has purchased can be listed along with its status, e.g., active or disposed of, the disposal method selected to dispose of the product, how long the product has been associated with the user account, a unique serial number for the product (which can be used to associate specific instances of a product with a specific user), etc.

Continuing with the description of FIG. 2, reward/penalty information 228 can include data indicative of the reward/penalty user 300 has earned due to his or her product purchasing and/or disposal behavior. For example, a reward stored in reward/penalty information 228 could include an icon indicative of a trophy created by an organization committed to acting in an environmentally friendly way. In another embodiment, reward/penalty information 228 could include a graphic indicative of a coupon, a gift certificate, information indicating free or reduced services given to user 300, etc. Similarly, reward/penalty information 228 can include penalties associated with user account 224 based on disposal and/or product purchasing behavior. For example, a penalty could be a fee charged to user 300, a trophy with a negative association, etc.

Each user account can also be associated with an ecological-impact score, which can be based in part on a user's estimated impact on the environment. In a specific example embodiment, an ecological-impact score can be a running score of the potential-ecological-impact quantifications associated with the user account. For example, suppose a user has an estimated impact score of zero points and purchase a mobile phone with a potential-ecological-impact quantification due to producing the mobile phone of 4 impact points. The user uses the mobile phone for three years and accumulates 5 impact points from charging the mobile phone over the years. After the three years user may throw the mobile phone out in a landfill and cause 3 impact points. The total potential-ecological impact for the mobile phone could be 12 impact points. In this specific example, the ecological-impact score for the user could be 12 impact points.

In another embodiment, potential-ecological-impact quantifications may be one factor used to calculate an ecological-impact score. In this specific example, the ecological-impact score can be adjusted by the amount of environmentally friendly activities the user undertakes, e.g., by purchasing carbon credits or performing other activities that have a positive effect on the environment. In another exemplary embodiment, the ecological-impact score can be adjusted based on how a user uses a product. For example, a user that purchases a car and drives it once a month is not efficiently using the vehicle and a better decision would have been for the user to take public transportation or join a car-sharing group such as Zipcar®. In this specific example, information that describes how intensely the product has been used could negatively/positively affect the user's ecological-impact score. In another exemplary embodiment, the ecological-impact score can be adjusted based on a group the user is a member of. For example, a user could be part of a “Green” group that sets requirements for how long products should be used before disposal. In this example, the user's compliance/noncompliance rate can affect his or her ecological-impact score.

Turning back to user account 224, a user account can have a friends list 232, which links user account 224 to other user accounts. Also shown is ecological statistics table 236, which can include information such as the number of times a user has selected an incineration mode of disposal vs. recycling or reselling mode of disposal, how user 300 compares to other users on his or her friends list, etc.

System 106 is also shown as including lifecycle module 118. For example, and described in more detail in the following paragraphs, lifecycle module 118 can be configured to generate an ecological-impact score for a user account, determine whether to display disposal mode indicators, (which are described in more detail in the following paragraphs), and/or search for various information within database 114, etc.

As shown by the figure, in an exemplary embodiment lifecycle module 118 can be associated with tables of information, which can be used in exemplary embodiments of the present disclosure to configure lifecycle module 118. Briefly, the tables can include, but are not limited to, threshold table 234, quantification adjustment table 242, image table 246, and/or reward/penalty table 248. Briefly, image table 246 can include images of products that can be associated with device-readable indicators. In an exemplary embodiment, products may not include device-readable indicators and LCM 118 can determine indicators from images. Quantification adjustment table 242 can include adjustment-quantifications that can be used to adjust ecological-impact scores based on certain criteria that will be described in more detail in the following paragraphs. Reward/penalty table 248 can include a list of rewards, e.g., positive rewards and penalties, which can be associated with a user account based on certain criteria described in more detail in the following paragraphs.

Group profile store 240 can be used to store information about one or more groups such as group 250, which user 300 may be a member of in an exemplary embodiment. A group can store information such as a group policy, which includes various criteria that can be used to adjust ecological-impact scores, reward users, etc. For example, a group policy can include a disposal timetable for a product or a type of product. The timetable can be used to determine whether a user has owned a product for an acceptable length of time before disposing of it according to disposal mode that causes harm to the environment. In a specific example, suppose product 102 is a mp3 player, and group profile 250 includes a list of acceptable disposal modes for the mp3 player, each of which is associated with a time-value. Also suppose that a user wants to dispose of the mp3 player by sending it to a landfill. In this example, a time-value for landfilling the mp3 player is 5 years. In this example, suppose a landfill disposal mode was selected for the mp3 player in year 3 of its existence. In this example, LCM 118 can calculate the amount of time the mp3 player has existed and compare it to the time-value. In this example, LCM 118 can determine that the mp3 player has been owned less than the time-value and generate an adjustment-quantification. For example, the adjustment-quantification could be 2, which indicates that the mp3 player is being disposed of 2 years early. LCM 118 can combine the adjustment-quantification with the potential-ecological-impact quantification for disposing of the mp3 player via a landfill and add the result to ecological-impact score.

Turning now to FIG. 3, it generally illustrates an exemplary environment, which could be product retailer location 106, product consumption location 108, or disposal facility 110. The dark dashed arrows indicate that product 102 could be optionally disposed of by placing product 102 in disposal receptacle 324, e.g., a recycling bin or trash, or given to another user such as user 318. Of course, in an exemplary embodiment where product comes in package 350, package 350 can also be given to user 318 or placed in disposal receptacle 324.

Device 302 may be a computing/communication device including, for example, a cellular phone, a personal digital assistant (PDA), a laptop, a desktop, or other type of computing/communication device. In an exemplary embodiment, device 302 may be a handheld device such as a cellular telephone, a smart phone, a Mobile Internet Device (MID), an Ultra Mobile Personal Computer (UMPC), a convergent device such as a personal digital assistant (PDA), and so forth. For example, device can include memory, e.g., random access memory, ROM, etc., that can contain executable instructions that can be executed by a processor. In addition, device 302 can include various integrated circuits such as GPS radios, network interface adaptors, etc., and the associated firmware that operates such devices. Device 302 can include user interface 310, which could include, but is not limited to, input components implemented by a combination of hardware and software such as a touch user interface, a keypad, a directional pad, a microphone, etc., and output components such as a screen, e.g., an liquid crystal display, a speaker, etc.

Device 302 can optionally include client database 342 and client lifecycle module 340. Device 302 can also include a network adaptor 352, which can be used to access network 100 and allow device 302 to communicate with ecological service provider 112. In an exemplary embodiment, client database 342 can include some or all of the data in database 114. For example, client database 342 can be configured to include a copy of user account 224, a copy of product information repository 202, a portion of product information repository 202 (the portion relating to products stored in product list 226), etc. Lifecycle module 340 can be a client side component that can perform some or all of the functions that LCM 118 can perform and/or Lifecycle module 340 can act as an interface to route information to LCM 118. An implementer may configure LCM 340 to perform certain functions and LCM 118 to perform others.

User 300 can optionally use device 302 to obtain ecological information about product 102 such as potential-ecological-impact quantifications. For example, product 102 can include memory, e.g., a barcode, random access memory, read-only memory, etc., which can be used to store information that can be used by device 302 to obtain information based off potential-ecological-impact quantifications and/or the potential-ecological-impact quantifications themselves, among other things.

As shown by the figure, product 102 can optionally include device-readable indicator 314, which can be information that can be extracted by device 302 in order to identify product 102. Device-readable indicator 314 could be an alphanumeric value, which can be stored in memory, e.g., RAM or ROM, in a barcode, in an RFID tag, or etched into product 102. In an exemplary embodiment, device-readable indicator 314 can be stored with a unique serial number that also identifies the specific instance of product 102. Device 302 can obtain device-readable indicator 314 by communicating with product 102 and/or extracting it from product 102 using a barcode reader 306, RFID reader 312, network adapter 352, or camera 304. In other exemplary embodiments, product 102 may not have an attached device-readable indicator, instead device-readable indicator 314 can be looked up from an image of product 102, audio of a user speaking about product 102, or from user input.

In an exemplary embodiment, a potential-ecological-impact quantification can be attached to product 102 in attached potential-ecological-impact quantification(s) 316. In this example, device 302 may be able to obtain one or more potential-ecological-impact quantifications from product 102 instead of from database 114 or client database 342. Similar to the aforementioned device-readable indicator 314, attached potential-ecological-impact quantification(s) 316 can be stored in memory, a barcode, an RFID tag, and/or etched onto product 102. In an exemplary embodiment where product 102 does not include attached potential-ecological-impact quantifications, LCM 118 or 340 can be used to obtain device-readable indicator 314, which can be used to search database 114 or 342 for potential-ecological-impact quantifications, among other things.

In yet another embodiment, product 102 may have one or more attached disposal mode identifiers 320. Disposal mode identifiers can include instructions, e.g., text, audio, images, for disposing of product according to a disposal mode, e.g., incineration, recycling, landfilling, etc. Similar to the aforementioned device-readable indicators, a disposal mode identifier may not be attached to product 102. Instead, this information could be stored within database 114 and/or client database 342.

In an exemplary embodiment, user 300 can use device 302 to obtain potential-ecological-impact quantifications for product 102 so he or she can learn about the potential-ecological impact associated with product 102. For example, suppose user 300 is interested in purchasing product 102, which could be a car, and may want to know the potential-ecological impact the car had on the environment by being produced. In this specific example, user 300 may obtain the potential-ecological impact the car had on the environment by using camera 304, e.g., a video camera and/or a still image camera, to take at least one picture of product 102. The one or more pictures can be processed by lifecycle module 340 and/or LCM 118 and device readable indicator 314 can be obtained by lifecycle module 340 and/or LCM 118. For example, the image can be compared to other images stored in image table 246 and a match can be made.

Alternatively, an RFID (radio frequency identifier) tag can be attached to the car and device-readable indicator 314 can be stored therein. In this exemplary embodiment, device 302 can include RFID reader 312, which can be configured to obtain device-readable indicator 314 from the car. Device-readable indicator 314 could then be used by LCM 118 and/or LCM 340 to search a database such as database 114 and/or client database 342.

In another specific example embodiment, suppose a network adaptor 354 is attached to the car. In this exemplary embodiment, device-readable indicator 314 can be stored in memory, e.g., RAM, ROM, etc. In this specific example, a point-to-point connection, e.g., via Bluetooth®, or a network connection, e.g., Wi-Fi, GSM, Wi-Max, etc., can be established between device 302 and product 102. The car can send information indicative of device-readable indicator 314 to device 302 within one or more packets of information via network adaptor 354. Network adapter 352 of device 302, e.g., a Wi-Fi radio, can receive the packets and extract device-readable indicator 314. Device-readable indicator 314 could then be used by LCM 118 and/or LCM 340 to search a database such as database 114 and/or client database 342.

Regardless of how device-readable indicator 314 is obtained, device 302 can use device-readable indicator 314 to obtain one or more potential-ecological-impact quantifications for the car in the instance that the car does not have attached potential-ecological-impact quantification(s) 316. For example, suppose device 302 includes LCM 340, which can interact with LCM 118 and does not include a client database in this specific example. Here, LCM 340 could request at least one potential-ecological-impact quantification associated with the production of the car from database 114 by sending device-readable indicator 314 to LCM 118, which can use device-readable indicator 314 to search production phase quantification table 216 for a potential-ecological-impact quantification associated with producing the car. For example, LCM 118 can receive a message which includes information such as a user account identifier for user account 224, device-readable indicator 314, and a value indicative of a request for a production potential-ecological-impact quantification for the product associated with device-readable indicator 314, i.e., the car. LCM 118 can receive the message and use device-readable indicator 314 to find a production potential-ecological-impact quantification for the car. LCM 118 can then send the potential-ecological-impact quantification to LCM 340 via network 100. In this example, LCM 340 can cause user interface 310 to render a bitmap in memory indicative of the potential ecological impact quantification. User interface 310 can then render the bitmap to a display.

Turning back to FIG. 3, at the end of a product's life it can be disposed of. In an exemplary embodiment, user 300 may want to know how to dispose of product 102 and how disposing of product 102 may affect the environment. In this example, user 300 may use user interface 310 to indicate to device 302 that he or she would like to dispose of product 102. Lifecycle module 340 could receive user input and obtain device-readable indicator 314. Client database 342 and/or database 114 can be searched and a disposal mode identifier and/or a potential-ecological-impact quantification can be found. User interface 310 can then display a disposal mode identifier and/or a potential-ecological-impact quantification. In another specific example, LCM 340 could extract a disposal mode identifier from attached disposal-mode identifier(s) 320 and/or a potential-ecological-impact quantification from attached potential-ecological-impact quantification(s) 316 in response to user input indicative of a request to dispose of product 102.

Product 102 can then be disposed of by user 300 by placing product 102 within a disposal receptacle 324. In an exemplary embodiment, disposal receptacle 324 can detect product 102 (by extracting a device readable indicator from product 102 and/or or passively inferring the presence of product 102 within disposal receptacle 324, e.g., by taking a picture of product 102). Disposal receptacle 324 can use network adaptor 356 to send device-readable indicator 314 to Lifecycle module 340 or LCM 118. Client database 342 and/or database 114 can be searched and a disposal mode identifier and/or a potential-ecological-impact quantification can be found. User interface 310 can then display a disposal mode identifier and/or a potential-ecological-impact quantification.

In another example, product 102 can be placed in disposal receptacle 324 and taken to disposal facility 110. In this example, an agent of disposal facility could extract device-readable indicator 314 and optionally the serial number of product 102 and send a message to LCM 118 that includes the serial number, device-readable indicator 314, and the identity of disposal facility 110. LCM 118 can use device-readable indicator 314 to find one or more disposal modes for product in disposal mode identifier table 214 and send the information back to disposal facility 110. The agent can then select one of the disposal modes. LCM 118 can then use the serial number to identify the user account that is associated with product 102 and update product list 226 to reflect that product 102 was disposed of by the disposal mode selected by disposal facility.

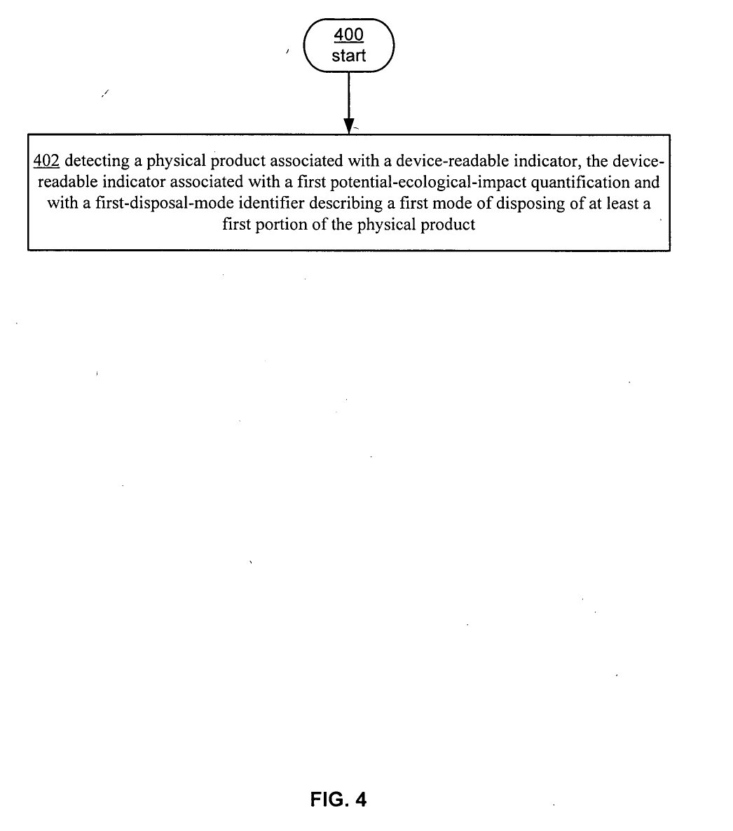

In FIG. 4 and in the following figures that include various examples of operational flows, discussions and explanations may be provided with respect to the above-described exemplary environment of FIGS. 1-3. However, it should be understood that the operational flows may be executed in a number of other environments and contexts, and/or in modified versions of FIGS. 1-3. Also, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

Turning now to FIG. 4, it illustrates an operational procedure including operations 400 and 402. Operation 400 begins the operational procedure and operation 402 shows detecting a physical product associated with a device-readable indicator, the device-readable indicator associated with a first potential-ecological-impact quantification and with a first-disposal-mode identifier describing a first mode of disposing of at least a first portion of the physical product. Referring to FIG. 3, in an exemplary embodiment, device 302, e.g., a mobile device, and/or system 106 can detect product 102, e.g., an article of clothing, such as product 102. In an exemplary embodiment, product 102 can be associated with a device-readable indicator such as device readable indicator 314, which can be used to detect product 102. Device-readable indicator 314 in turn can be associated with both a first-potential-ecological-impact quantification and a first-disposal-mode identifier. The first-disposal-mode identifier in this example can describe a first mode of disposing of at least a portion of product 102. The potential-ecological-impact quantification could quantify the potential impact the first mode of disposing of at least the portion of product 102 may have on the environment.

In a specific example embodiment, suppose product 102, e.g., an mp3 player, includes network adaptor 354, which could be a Bluetooth® adapter and device 302 is a mobile phone including network adaptor 352, which can also be a Bluetooth® adapter. In this example, device 302 (the mobile phone in this example) can be paired with product 102 (the mp3 player). When the mp3 player comes within signal range of the mobile phone, device 302 can exchange information, e.g., pair, with product 102 can detect product 102.

Continuing with the specific example, device-readable indicator 314 can be alphanumerical data, which can be obtained by device 302. Device-readable indicator 314 in this example can be linked to the first-potential-ecological-impact quantification and the first-disposal-mode identifier. For example, the first-potential-ecological-impact quantification and the first-disposal-mode identifier can be stored in database 114 along with a relationship to device-readable indicator 314. In a specific example, suppose that the first disposal-mode identifier describes a landfill disposal mode, e.g., it is associated with instructions such as “place product within a blue trash can to dispose of product via a landfill,” and the first potential-ecological-impact quantification indicates the potential harm caused by disposing of the mp3 player by sending it to a landfill, e.g., the potential-ecological-impact quantification could be a value such as “average” to indicate that the mp3 play will cause moderate harm to the environment if it is landfilled.

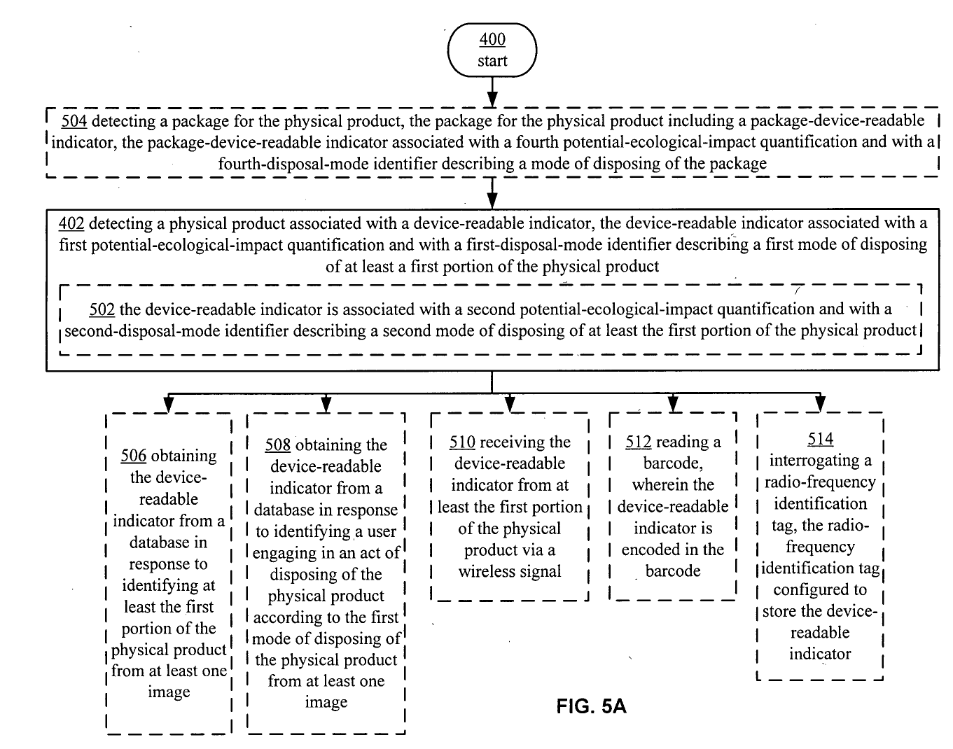

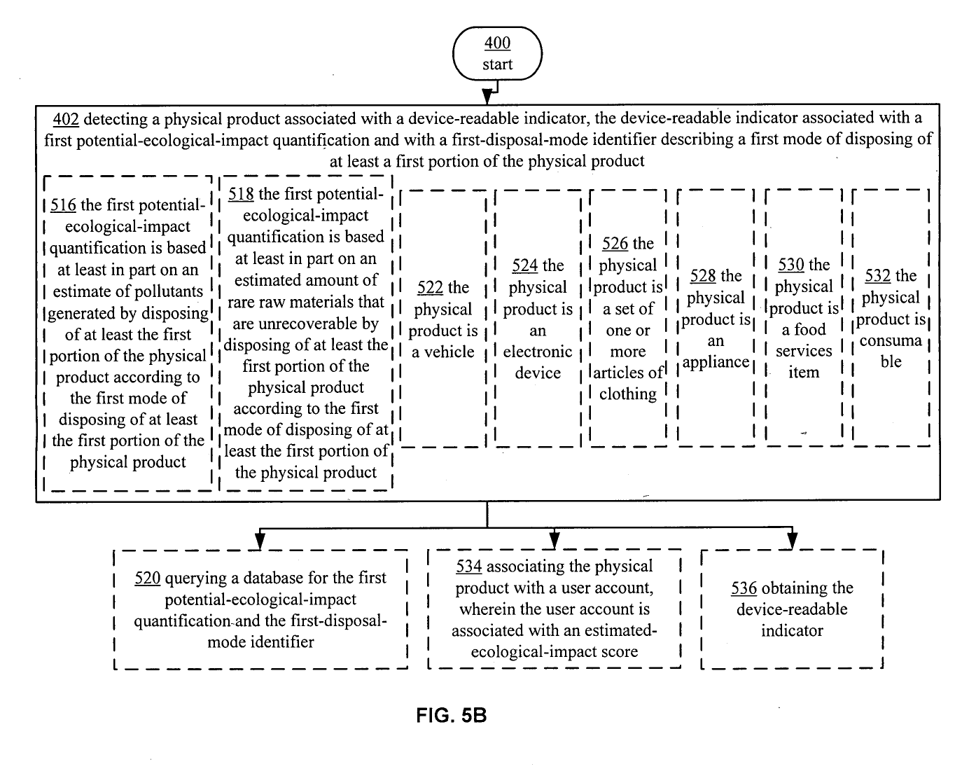

Turning now to FIGS. 5A and 5B, these figures illustrates an alternative embodiment of the operational procedure illustrated by FIG. 4 including additional operations/refinements 502-536. The following optional operations are illustrated across multiple pages for clarity purposes and one of skill in the art can appreciate that operations 502-534 could be illustrated in the same figure but for space restrictions. Refinement 502 shows that in an exemplary embodiment, the device-readable indicator is associated with a second potential-ecological-impact quantification and with a second-disposal-mode identifier describing a second mode of disposing of at least the first portion of the physical product. For example, and referring again to FIG. 3, in this exemplary embodiment, device-readable indicator 314 can be associated with both a second potential-ecological-impact quantification and with a second-disposal mode identifier. For example, in this exemplary embodiment, product 102 can be associated with two disposal modes for at least the first portion of product 102. For example, product 102, e.g., a tire, could be associated with at least two disposal-mode identifiers describing two disposal modes in an exemplary embodiment.

In a specific example, and continuing from the previous example discussed with respect to FIG. 4, the mp3 player can have the potential-ecological-impact quantification that reflects potential harm caused to the environment by landfilling the mp3 player and another potential-ecological-impact quantification that reflects harm caused to the environment by incinerating the mp3 player. In addition to the second potential-ecological-impact quantification, a second disposal-mode identifier that describes a way to have the mp3 player incinerated can also be associated with device-readable indicator 314. For example, the second-disposal-mode identifier can be associated with text that states “place product within a red trash can to have the mp3 player incinerated.” Both the first and second potential-ecological-impact quantifications can be stored in disposal phase quantification table 220 along with an association to device-readable indicator 314 and/or on the mp3 player.

Continuing with the description of FIG. 5A, operation 504 shows detecting a package for the physical product, the package for the physical product including a package-device-readable indicator, the package-device-readable indicator associated with a fourth potential-ecological-impact quantification and with a fourth-disposal-mode identifier describing a mode of disposing of the package. For example, and referring to FIG. 3, in an embodiment user 300 can receive a package, e.g., a cardboard box, such as package 350 that includes product 102. As shown by the figure, in an exemplary embodiment, product package 350 can be associated with device-readable indicator 358. In this exemplary embodiment, device-readable indicator 358 may be associated with a potential-ecological-impact quantification and with a disposal-mode identifier for disposing of package 350. Device 302 can detect the product package 350 in this example using camera 304, RFID reader 312, barcode reader 306, and/or network adaptor 352.

In a specific example, product package 350 may include a barcode encoding an alphanumeric value indicative of device-readable indicator 358. In this specific example, device 302 can include barcode reader 306, which can be used to extract device-readable identifier 358. Suppose that device 302 is configured to extract device-readable indicator 358 in response to a request received via user interface 310. For example, device 302 could have downloaded a web-page generated by social networking module 116 and rendered on user interface 310 that includes logic operable to receive device-readable identifier 358 and send device-readable identifier 358 to social networking module 116. Social network module 116 can route the device-readable identifier 358 to LCM 118, which can search database 114 for a potential-ecological-impact quantification and a disposal-mode identifier for disposing of package 350. LCM 118 can route the potential-ecological-impact quantification and the disposal-mode identifier for disposing of package 350 back to social network module 116, which can generate a web-page including the potential-ecological-impact quantification and/or the disposal mode identifier for disposing of package 350 and send the web-page to device 302. A web-browser (not shown) can receive the web-page and cause user interface 310 to display the potential-ecological-impact quantification and/or the disposal mode identifier for disposing of package 350.

Continuing with the description of FIG. 5A, operation 506 illustrates obtaining the device-readable indicator from a database in response to identifying at least the first portion of the physical product from at least one image. For example, and referring to FIG. 3, device 302 can be configured to obtain device-readable indicator 314 from a database such as image table 246 using at least one image of product 102 as a search parameter. Thus, in this example, device-readable indicator 314 may not be attached to product 102. Instead, LCM 118 or 340 can determine device-readable indicator 314 from a picture of product 102. For example, device 302 can include camera 304, which can be configured to take still images and/or video, i.e., a series of images. In this example, camera 304 can capture an image of product 102, for example, in response to user input. Camera 304 can pass the one or more images to LCM 340 and/or LCM 118, which can search image table 246 using the one or more images as search parameter(s); find an image matching product 102; and receive device-readable indicator 314 from the image table 246. In this exemplary embodiment, device-readable indicator 314 may be a hash of the information in the image, or any other identifier associated with the image table 246 that can be used by LCM 118 to search for information within database 114.

In a specific example, suppose that disposal receptacle 324 is a recycling bin and is associated with a camera such as camera 326 and a network adaptor such as network adaptor 356. For example, camera 326 can be mounted on an adjacent wall and pointed at the recycling bin. In this example, user 300 may dispose of the soda-pop can by tossing the can in the recycling bin. In this example, camera 326 can be configured to capture images whenever a user places something within the recycling bin. Camera 326 can capture one or more images that depict the soda-pop can being thrown out and send the images via network adaptor 356 to LCM 118. LCM 118 can receive the images and analyze them to identify the soda-pop can and then LCM 118 can search image table 246 to find an image that matches the soda-pop can. In this example, LCM 118 can find a match and select the device-readable identifier associated with the image in image table 246 that is the match.

Referring to operation 508, it shows obtaining the device-readable indicator from a database in response to identifying a user engaging in an act of disposing of the physical product according to the first mode of disposing of the physical product from at least one image. For example, and again referring to FIG. 3, camera 326, which can be associated with disposal receptacle 324, e.g., a trash can, which can be associated with a specific disposal method, e.g., disposal receptacle 324 can be a recycling bin, a landfill bin, a compost bin, an incineration bin, etc. Camera 326 can be configured to capture one or more images of user 300 engaging in a disposal act, e.g., throwing product 102 out. The one or more images can then be used to search a database such as image table 246 for a device-readable indicator (device-readable indicator 314 for example) that corresponds to the product (product 102 in this example) in the one or more images. For example, camera 326 could be mounted on the wall next to disposal receptacle 324 and be configured to capture images associated with this disposal receptacle 324. In the instance that user 300 throws product 102 out by placing it in disposal receptacle 324, camera 326 can send the one or more images and information identifying the disposal method associated with disposal receptacle 324 to LCM 118 or 340 using network adaptor 356. LCM 118 can search image table 246 using the one or more images as search parameter(s); find an image matching product 102; and receive device-readable indicator 314 from the image table 246. In this example, LCM 118 can also determine that user 300 was engaged in a specific disposal method based on the information identifying the disposal method associated with disposal receptacle 324.

In a specific example, suppose product 102 is a worn out shirt and a camera such as camera 326 is mounted on a wall adjacent to four different disposal receptacles: a recycling bin, a landfill bin, a compost bin, and an incineration bin. In this example, user 300 may view the different disposal receptacles; decide to landfill his or her shirt; and dispose of the shirt by tossing it into the landfill disposal bin. Camera 326 can capture one or more images that depict the shirt being thrown into the landfill bin and send the images via network adaptor 356 to LCM 118. LCM 118 can receive the images and analyze them to identify the shirt and the landfill bin and then LCM 118 can search image table 246 to find an image that matches the shirt and obtain the device-readable identifier associated with shirt. LCM 118 can use the device-readable identifier for the shirt to obtain, for example, a potential-ecological-impact quantification associated with disposing the shirt by landfilling it.

Continuing with the description of FIG. 5A, operation 510 shows receiving the device-readable indicator from at least the first portion of the physical product via a wireless signal. For example, and again referring to FIG. 3, device 302 can be configured to receive a wireless signal that includes device-readable indicator 314 from a wireless signal, which could be network 100 in an example embodiment. In this example, network adaptor 352 can be configured to receive one or more packets of information indicative of device-readable indicator 314 via network 100. For example, product 102 could include network adaptor 354 and use it to transmit a wireless signal indicative of device-readable indicator 314 to device 302. In another example, LCM 118 can be configured to receive device-readable indicator 314 from product 102 by way of device 302. In a specific example, the wireless network could be a wireless network that encodes signals according to one or a plurality of formats. For example, the wireless network could be a Wi-Fi network, a WiMax network, a wireless personal area network, e.g., a network that exchange signals that are compliant with the Institute of Electrical and Electronics Engineers (IEEE) 802.15 standard, a mobile phone network such as a Code Division Multiple Access (CDMA) or a Global System for Mobile Communications (GSM) based mobile network. In another specific example, the signal could be a point-to-point communication. For example, network adaptor 354 and 352 could exchange information using signals that are compliant with the Bluetooth® standard, a near-field communication standard, e.g., a European Computer Manufacturers Association (ECMA) standard number 340 or International Organization for Standardization number 14443, or the Zigbee standard.

In a specific example embodiment, suppose that device 302 includes client lifecycle module 340, which can render a user interface on user interface 310, e.g., a touch interface, that allows user 300 to indicate that he or she would like to dispose of a product. For example, user 300 may select a button associated with text that states “identify products.” In response to the selection, client lifecycle module 340 could cause network adaptor 352 to ping products in the immediate area using, for example, a Wi-Fi network. In this example, product 102 could reply and device 302 can establish a communication channel to product 102 via, for example, the Wi-Fi network. Device 302 may then request device-readable indicator 314. Product 102 may respond with device-readable indicator 314 over the communication channel and device 302 can receive one or more packets of information indicative of device-readable indicator 314.

In another specific example, suppose that user 300 purchases product 102 and brings product 102 home. In this example, user 300 may add product 102 to the Wi-Fi network he or she maintains. In this example, device 302 may be a mobile phone that is also attached to the Wi-Fi network. Here, product 102 may detect the presence of device 302 on the wireless network and send one or more packets of information indicative of device-readable indicator 314 to device 302. Device 302 may store device-readable indicator 314 in product list 226 of client database 342 and/or database 114.

In yet another specific example, and referring to FIG. 1, LCM 118 can receive one or more packets of information indicative of the device-readable indicator 314 via network 100 from a device located at disposal facility 110, i.e., a device similar to device 302 of FIG. 3. In this example, an agent of the disposal facility 110 may have sent device-readable indicator 314 to ecological service provider 112 in response to user 300 indicating that he or she would like to dispose of product 102.

Turning now to operation 512 of FIG. 5A, it shows reading a barcode, wherein the device-readable indicator is encoded in the barcode. For example, and referring to FIG. 3, in an exemplary embodiment, product 102 can include a barcode, e.g., a one-dimensional or two-dimensional symbol, that contains information indicative device-readable indicator 314. In an exemplary embodiment, device 302 could include a barcode reader 306. In another exemplary embodiment, device 302 could use camera 304 to capture an image of the barcode. The image could then be used to determine device-readable indicator 314.

In a specific example, suppose device 302 includes client lifecycle module 340. The user 300 in this example would like to learn about product 102, which could be a shirt. In this example, the shirt could include a barcode attached to, for example, a tag. In this specific example, user 300 can hold device 302 up to the tag and select a button rendered on user interface 310 that causes device 302 to read the barcode. Device 302 can read the barcode and extract device-readable indicator 314.

Referring to operation 514, it shows interrogating a radio-frequency identification tag, the radio-frequency identification tag configured to store the device-readable indicator. For example, and referring to FIG. 3, suppose product 102 includes an RFID tag that includes device-readable indicator 314. In this exemplary embodiment, device 302 can be configured to interrogate the RFID tag attached to product 102 using RFID reader 312 and obtain device-readable indicator 314 from the RFID tag.

In a specific example, the RFID tag attached to product 102 can be a passive RFID tag or a battery assisted RFID tag. In either case, user 300 may desire disposal information for product 102 and press a button displayed on user interface 310. In response to the button selection, device 302 can configure RFID reader 312 to interrogate RFID tags within a predetermined distance from device 302. In this example, the RFID tag attached to product 102 can receive a signal, which causes the RFID tag to transmit device-readable indicator 314. RFID reader 312 can detect the transmitted device-readable indicator 314 and RFID reader 312 can store the device-readable indicator 314 in its memory.

Turning to FIG. 5B, refinement 516 shows that in an exemplary embodiment, the first potential-ecological-impact quantification is based at least in part on an estimate of pollutants generated by disposing of at least the first portion of the physical product according to the first mode of disposing of at least the first portion of the physical product. For example, in an embodiment the first potential-ecological-impact quantification, i.e., a value such as 10 impact points, can be based on pollutants potentially released into the environment if product 102 is disposed of in accordance with the disposal method associated with the first-disposal-mode identifier. For example, in an exemplary embodiment the first-disposal-mode identifier could be for landfilling product 102 and the first potential-ecological-impact quantification can be based on an estimated amount of pollutants that would be released into the environment if product 102 was placed in a landfill.

In a specific example, a product's composition of heavy metals, persistent organic pollutants, polycyclic aromatic hydrocarbons, volatile organic compounds, and/or environmental xenobiotics, CO₂e emissions associated with product 102 as it decomposes, CO₂e emissions of equipment used to effect the disposal-mode, e.g., trucks, incinerators, or other heavy machinery, etc., can be used to generate the first potential-ecological-impact quantification. This information could have been previously determined and stored in various tables in database 114 such as ground pollutant table 208, CO₂e table 206, etc., and subsequently used to generate the first potential-ecological-impact quantification.

Refinement 518 shows that in an exemplary embodiment, the first potential-ecological-impact quantification is based at least in part on an estimated amount of rare raw materials that are unrecoverable by disposing of at least the first portion of the physical product according to the first mode of disposing of at least the first portion of the physical product. For example, in an embodiment the first potential-ecological-impact quantification, i.e., a value such as “good,” “bad,” “neutral,” can be based on an estimated amount of rare raw materials, e.g., rare-earths, that will not be recoverable if product 102 is disposed of according to the first mode of disposing of product 102. For example, rare material information for product 102 can be stored in rare materials table 210 and used along with information about different disposal modes to estimate the amount of rare raw materials that are unrecoverable if the product is incinerated, landfilled, etc. The estimates can then be used to generate disposal mode potential-ecological-impact quantifications that can be stored in disposal phase mode quantification table 220.

Referring now to operation 520, it shows querying a database for the first potential-ecological-impact quantification and the first-disposal-mode identifier. For example, and referring to FIG. 3, in an exemplary embodiment, suppose that both the first potential-ecological-impact quantification and the first-disposal-mode identifier are stored in a database such as database 114. In this example, device 302 can send a message to LCM 118 that includes device-readable indicator 314 and a request for the first potential-ecological-impact quantification and the first-disposal-mode identifier for product 102. For example, device 302 may have previously obtained device-readable indicator 314, e.g., by searching client database 342 or 114 for it based on an image of product 102, or by receiving device-readable indicator 314 from product 102 via network 100 or barcode reader 306, etc. After LCM 118 receives device-readable indicator 314 and the request, LCM 118 can use device-readable indicator 314 to query disposal mode identifier table 214 and disposal phase quantification table 220; obtain both the first potential-ecological-impact quantification and the first-disposal-mode identifier and send them to device 302 via network 100.

In a specific example, suppose user 300 indicates that he or she would like to dispose of product 102, and presses a button on device 302, which may be a personal computer system running in the user's house. In response to user input, device 302 can obtain device-readable indicator 314 and send a request via network adaptor 352 to ecological service provider 112 for disposal mode information associated with device-readable indicator 314, e.g., a first potential-ecological-impact quantification and a first-disposal-mode identifier. System 106, e.g., a cluster of computer systems, of ecological service provider 112, can receive the request and LCM 118 can execute a search of database 114 for the first potential-ecological-impact quantification and the first-disposal-mode identifier using device-readable indicator 314 as a parameter. LCM 118 can find the information and route the information to network adapter 352, which can send the information back to device 302 via one or more packets of information.

Referring to refinement 522, it shows that in an exemplary embodiment the physical product is a vehicle. For example, in an embodiment physical product 102 can be a vehicle such as a car, boat, scooter, bike, etc. In this example embodiment, the first potential-ecological-impact quantification could be associated with the ecological impact due to sending the vehicle to a junkyard.

Referring to refinement 524, it shows that in an exemplary embodiment the physical product is an electronic device. For example, in an embodiment physical product 102 can be an electronic device, e.g., any type of device that consumes electricity. For example, product 102 can be any type of consumer electronic device such as a television, e.g., LCD, plasma, etc., a monitor, e.g., a CRT monitor, LCD monitor, etc., a Blu-ray player, a DVD player, a stereo, a mobile phone, a personal computer, a laptop, a tablet computing device, a portable music playing device, etc. Physical product 102 can also be a peripheral device, for example, product 102 could be a speaker, an uninterruptible power supply, a pair of headphones, etc. Physical product 102 can also be a discrete component of another device, for example, product 102 could be a disk drive, a PCI device, e.g., a PCI-express video card, a CPU, a chip of random access memory, etc. In this example embodiment, the first potential-ecological-impact quantification could be associated with the ecological impact due to recycling the computing device or any other type of ecological impact.

Referring to refinement 526, it shows that in an exemplary embodiment the physical product is a set of one or more articles of clothing. For example, in an embodiment physical product 102 can be a set of one or more articles of clothing, e.g., a pair of shoes, a shirt, a hat, a coat, undergarmets, etc. In an example embodiment, the first potential-ecological-impact quantification could be associated with the ecological impact due to incinerating the physical product.

Referring to refinement 528, it shows that in an exemplary embodiment the physical product is an appliance. For example, in an embodiment physical product 102 can be an appliance such as a blender, oven, washing machine, etc. In an example embodiment, the first potential-ecological-impact quantification could be associated with the ecological impact due to recycling the appliance.

Referring to refinement 530, it shows that in an exemplary embodiment the physical product is a food services item. For example, in an embodiment physical product 102 can be a food service item such as a disposable cup, e.g., a to-go coffee cup. In an example embodiment, a first potential-ecological-impact quantification could be associated with the ecological impact due to composting the food service item.

Referring to refinement 532, it shows that in an exemplary embodiment, the physical product is a consumable. For example, in an embodiment, physical product 102 can be a product that is capable of being consumed, e.g., “used up,” wasted, spent, dissipated, etc. For example, a consumable product could be an office supply, e.g., a box of pens, package of paper, an ink cartridge, etc. In this example, each pen, ink cartridge, sheet of paper, etc., could be associated with a device-readable indicator. Alternatively, the container that the consumable is sold in can be associated with a device-readable indicator. For example, a consumable could be drugs, e.g., in a container, prescription or over the counter drugs, disposable needles, e.g., or other medical and/or bio-hazardous materials. A consumable product could also be a container of liquid or solvent. For example, a consumable product could be a container of paint, thinner, glue, propane, oil, transmission fluid, power steering fluid, a household cleaning product, e.g., bleach, disinfectants, laundry detergent, surface cleaner, etc. The container that houses the liquid or solvent could be associated with a device-readable indicator that in turn is associated with a potential-ecological-impact quantification.

Operation 534 shows associating the physical product with a user account, wherein the user account is associated with an ecological-impact score. For example, and referring to FIG. 2, in an exemplary embodiment LCM 118 can receive a message indicating that user 300 obtained control of product 102, e.g., user 300 purchased product 102. In an exemplary embodiment, the message can identify a user account such as user account 224 and identify product 102, e.g., the signal could include device readable indicator 314. LCM 118 can add information indicating that the user has obtained product 102 to user account 224. In a specific example, device-readable indicator 314 could be stored in product list 226.

In another specific example, suppose user 300 purchases product 102, e.g., a car. In this example, client LCM 340 could render an image indicative of user account 224 on user interface 310, e.g., a touch display. User interface 310 can receive user input that allows user 300 to input, for example, device readable indicator 314 into a dialog box that has associated text such as “Insert device readable indicator to associate product with your user account.” User 300 could type the device readable indicator 314 into the box, (or optionally obtain device readable indicator 314 from the car itself using Wi-Fi, barcode reader 306, RFID reader 312, etc.) After device-readable indicator 314 is input into the box, lifecycle module 340 can associate the car with user account 224 by storing information indicative of device-readable indicator 314 in client database 342, e.g., in a cached copy of user account 224. Client database 342 can synchronize with database 114 and database 114 can also store information indicative of device-readable indicator 314 in user account 224, e.g., in product list 226.

In another specific example, instead of storing device-readable identifier 314 in client database 342, LCM 340 can cause network adaptor 352 to send one or more packets of information indicative device-readable identifier 314 to ecological service provider 112, which can forward the information to LCM 118. Lifecycle module 118 can receive the information and store it in database 114.

In yet another specific example, a web-page indicative of a user interface screen can be generated by, for example, social networking module 116 and sent to device 302. In this example, the web-page can include logic that allows a user to input device-readable identifier 314 into the web-page. In this specific example, device 302 may not include database 114 or lifecycle module 340. Instead, a web-page can be displayed by user interface 310 and user 300 can input device-readable identifier 314. When the user selects a save button, one or more packets indicative of device-readable identifier 314 can be sent by network adaptor 352 to social networking module 116. The information can be routed to lifecycle module 118, which can store the information in, for example, product list 226 of user account 224.

Turning now to operation 536, it shows obtaining the device-readable indicator. For example, and referring to FIG. 3, in an exemplary embodiment device 302 can be configured to obtain device-readable identifier 314. For example, LCM 340 can obtain device-readable identifier 314 from barcode reader 306, which may have read a barcode on product 102 that contains device-readable identifier 314.

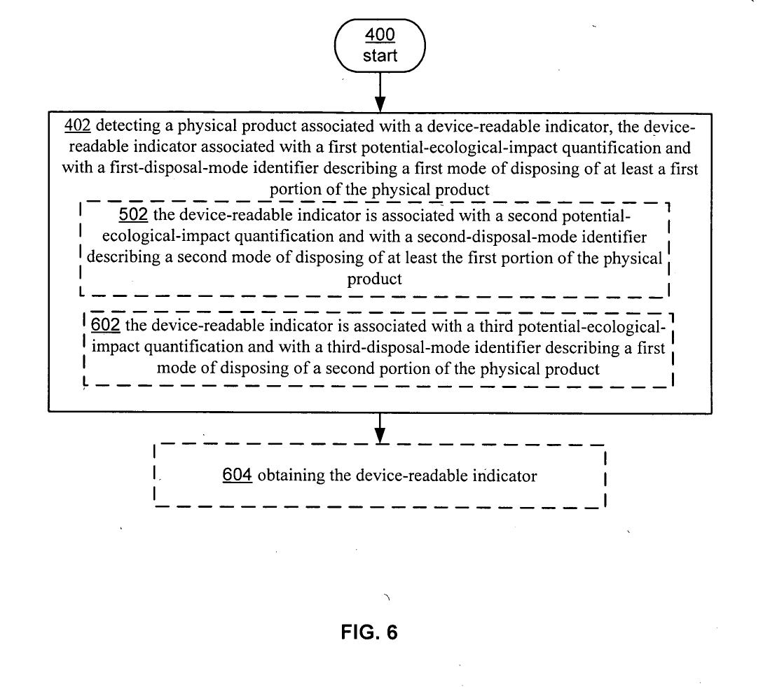

Turning now to FIG. 6, it illustrates an alternative embodiment of the operational procedure illustrated by FIG. 5A. As shown by the figure, the additional operations can include operations 602-604.

Operation 602 illustrates that in an exemplary embodiment, the device-readable indicator is associated with a third potential-ecological-impact quantification and with a third-disposal-mode identifier describing a first mode of disposing of a second portion of the physical product. For example, and referring to FIG. 3, in an exemplary embodiment, product 102 can be the combination of multiple parts, e.g., a mp3 player could be formed from a battery and a housing. In this example embodiment, the second portion of product 102, e.g., the battery, may be associated with a disposal-mode identifier and a potential-ecological-impact quantification.

In a specific example, product 102 may be a printer and may use an ink cartridge. In this example, device-readable identifier 314 can be associated with a potential-ecological-impact quantification and a disposal-mode identifier for both the printer and the ink cartridge. In this exemplary embodiment, suppose user 300 wishes to obtain disposal information for the printer. In this example, user 300 could select an icon rendered on user interface 310 that causes LCM 340 to communicate with the printer using, for example, a wireless signal conforming to the Bluetooth® protocol. LCM 340 could receive device-readable identifier 314 and lookup device-readable identifier 314 in database 114 by sending a signal via network 100 to LCM 118. LCM 118 look up the potential-ecological-impact quantification and the disposal-mode identifier for both the printer and the ink cartridge and send information of the same to LCM 340.

Turning now to operation 604, it shows obtaining the device-readable indicator. For example, in an exemplary embodiment and referring to FIG. 3, device 302 can obtain device-readable indicator 314, which can be associated with the first disposal-mode identifier and the second disposal-mode identifier. That is, at least a portion of product 102 can be associated with different disposal modes. For example, product 102 could be a toaster oven, and the first-disposal-mode identifier could be associated with a landfilling mode of disposal for the toaster oven and the second-disposal-mode identifier could be associated with a recycling mode of disposal for the toaster oven.

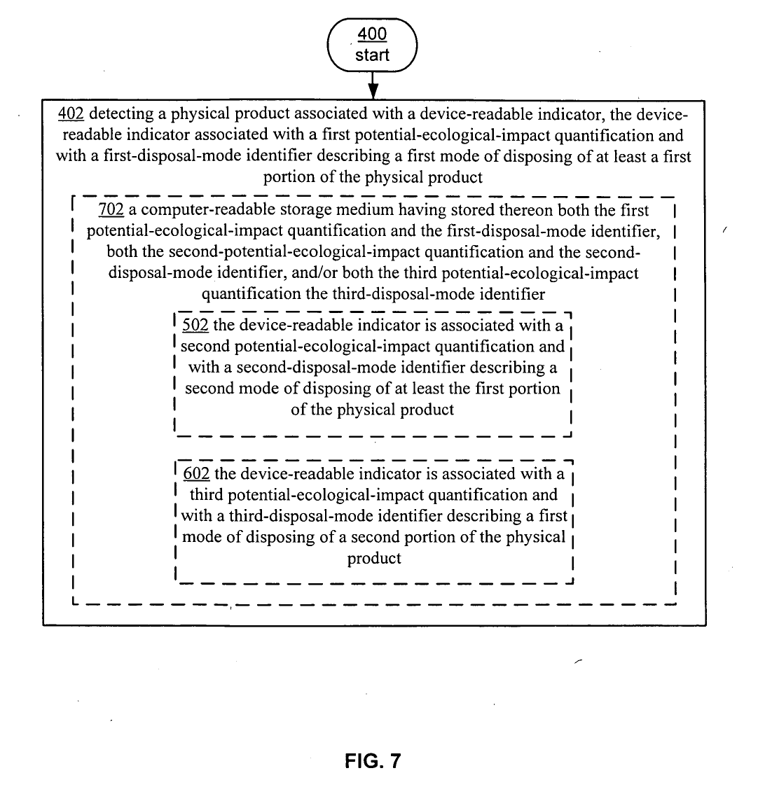

Turning now to FIG. 7, it illustrates an alternative embodiment of the operational procedure illustrated by FIG. 6. As shown by the figure, the operational procedure can include the additional refinement 702.

Refinement 702 shows that in an exemplary embodiment, the physical product can include a computer-readable storage medium having stored thereon both the first potential-ecological-impact quantification and the first-disposal-mode identifier, both the second-potential-ecological-impact quantification and the second-disposal-mode identifier, and/or both the third potential-ecological-impact quantification the third-disposal-mode identifier. For example, and referring to FIG. 3, in an exemplary embodiment, product 102 can include computer-readable storage medium such as a read-only memory integrated within, for example, an RFID tag or an integrated circuit attached to a motherboard. In this exemplary embodiment, the computer-readable storage medium can store both the first potential-ecological-impact quantification and the first-disposal-mode identifier, both the second-potential-ecological-impact quantification and second-disposal-mode identifier, and/or both third potential-ecological-impact quantification and third-disposal-mode identifier.

In a specific example, product 102 can be a watch that includes read-only-memory. In this example, the read-only memory in this specific example can have both the first potential-ecological-impact quantification and the first-disposal-mode identifier, both the second-potential-ecological-impact quantification and second-disposal-mode identifier, and/or both third potential-ecological-impact quantification and third-disposal-mode identifier encoded therein. In this example, the watch could include a network adaptor 354, which can be used to communicate information stored in the read-only-memory to device 302 in response to a request. Network adapter 352 can receive information indicative of, for example, the first potential-ecological-impact quantification and the first-disposal-mode identifier from the watch and route the information to LCM 340. LCM 340 can generate a bitmap indicative of, for example, the first potential-ecological-impact quantification and instructions describing how to dispose of the watch according to the first disposal mode and cause user interface 310 to render the bitmap.

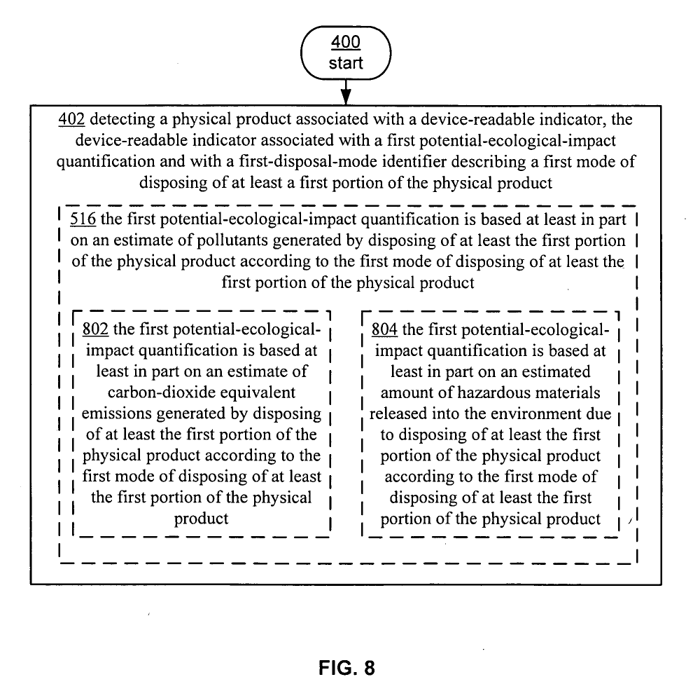

Turning now to FIG. 8, it illustrates an alternative embodiment of the operational procedure illustrated by FIG. 5B. As shown by the figure, the operational procedure can include the additional refinements 802 and 804.

Refinement 802 shows that in an exemplary embodiment, the first potential-ecological-impact quantification is based at least in part on an estimate of carbon-dioxide equivalent emissions generated by disposing of at least the first portion of the physical product according to the first mode of disposing of at least the first portion of the physical product. For example, a first potential-ecological-impact quantification associated with product 102 can be based at least in part on the estimated CO₂e that would be emitted if product 102 was disposed of according to the first disposal mode. For example, and referring to FIG. 2, CO₂e table 206 associated with product 102 could be collected and used to generate a potential-ecological-impact quantification for disposing of at least a portion of product 102 according to a first mode, which could be an incineration disposal mode. In this example, an estimate of the amount of CO₂e that would be emitted if the tire was incinerated can be calculated and used to generate an incineration potential-ecological-impact quantification.

In a specific example, suppose that product 102 is a can of soda-pop. In this example, the can of soda-pop can be associated with a disposal potential-ecological-impact quantification that takes into account the CO₂e emissions from disposing of the can according to the first mode, which could be an incineration disposal mode. Or put another way, an incineration disposal mode can take into account at least the CO₂e emissions caused by incinerating the can. In this example, the potential-ecological-impact quantification due to incinerating the can could be 1, which indicates that incinerating the can causes a slight amount of carbon dioxide equivalent gas to be emitted.

Continuing with the description of FIG. 8, refinement 804 shows that in an exemplary embodiment, the first potential-ecological-impact quantification is based at least in part on an estimated amount of hazardous materials released into the environment due to disposing of at least the first portion of the physical product according to the first mode of disposing of at least the first portion of the physical product. For example, in an embodiment, a first potential-ecological-impact quantification associated with product 102 can be based at least in part on the estimated amount of hazardous materials that could potentially be released into the environment if product 102 was disposed of according to the first disposal mode. For example, and referring to FIG. 2, hazardous materials table 204 associated with product 102 could include information about the materials in product 102, the materials that could be released into the environment by product 102, the amount of exposure a living organism, e.g., a human, or ecological receptor, has with the contaminated material, and the inherent toxicity of the material, etc. This information could be used to generate a potential-ecological-impact quantification for disposing of at least a portion of product 102 according to a first mode that takes into account the release of hazardous materials that could be released into the environment.

In a specific example, product 102 could be cleaning product that includes carcinogens and the disposal mode may be by landfill. In this example, the harm the chemicals could potentially cause to the environment if they got into the water supply could be estimated and used to generate a potential-ecological-impact quantification for the cleaning product.

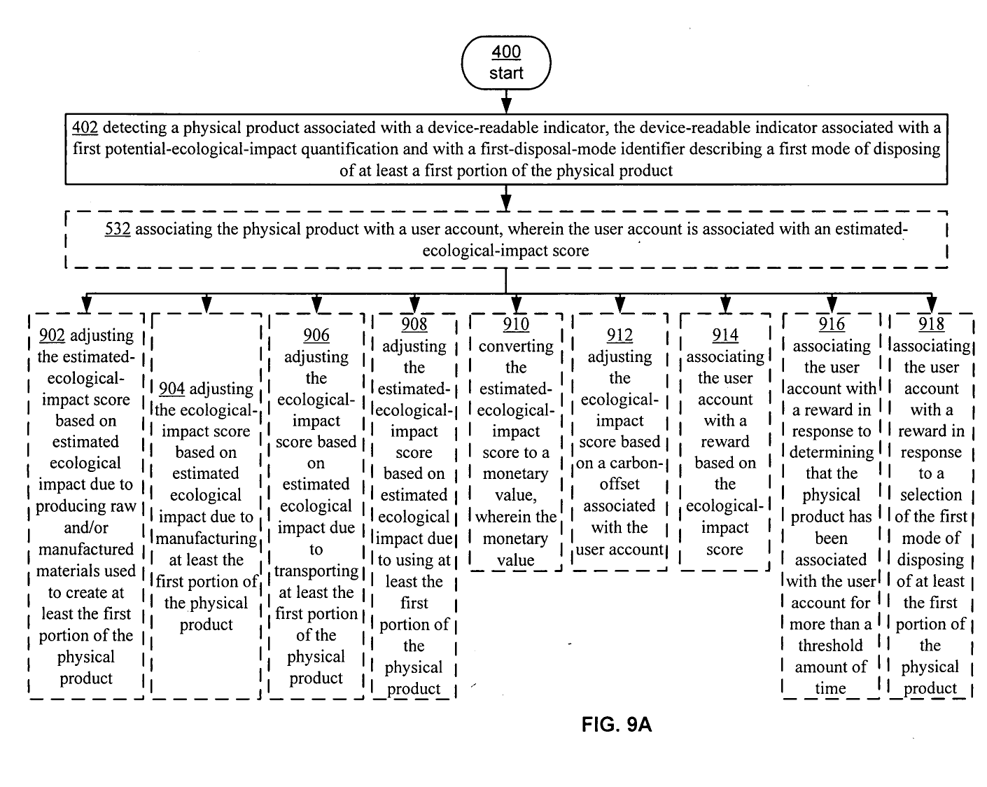

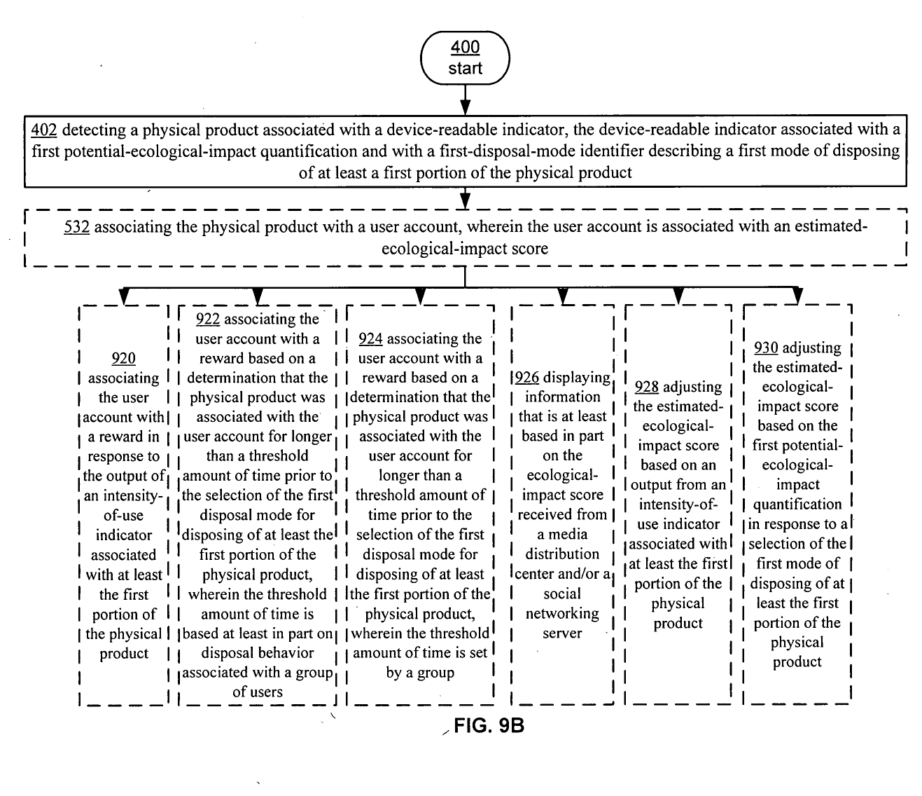

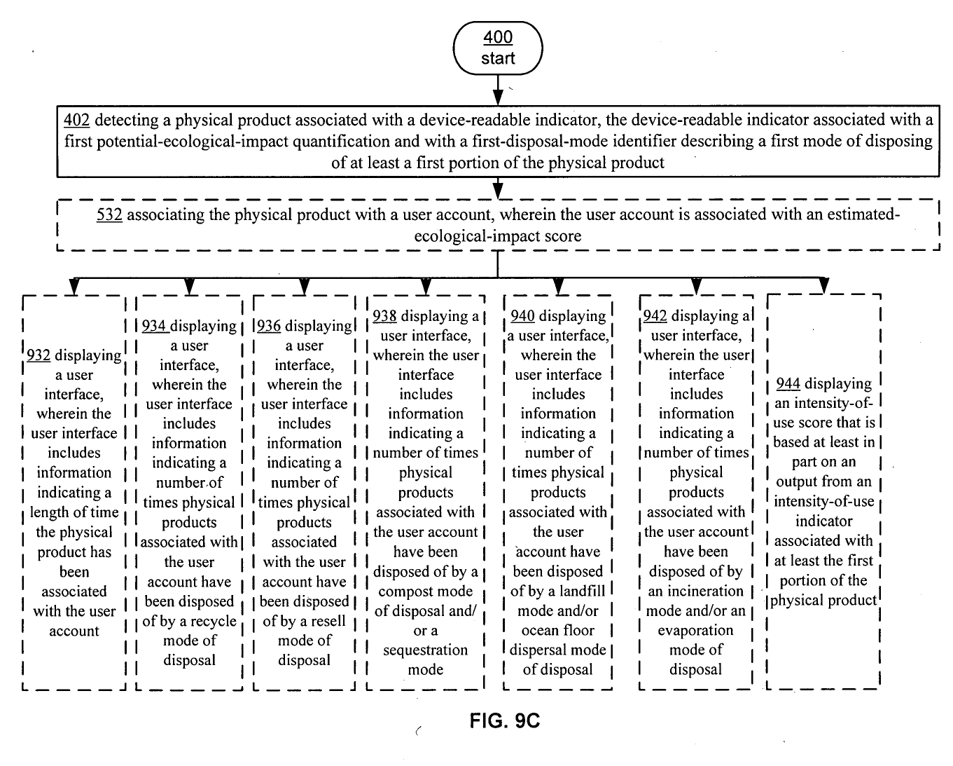

Turning now to FIG. 9, this figure is separated into three figures (FIGS. 9A, 9B, and 9C) for clarity purposes. FIG. 9A it illustrates an alternative embodiment of the operational procedure illustrated by FIG. 5B. As shown by the figure, the operational procedure can include the additional operations 902-918.

In an exemplary embodiment, the physical product can be associated with a user account and operation 902 shows adjusting the ecological-impact score based on estimated ecological impact due to producing raw and/or manufactured materials used to create at least the first portion of the physical product. For example, and turning to FIG. 2, in an exemplary embodiment, lifecycle module 118 can be configured to adjust ecological-impact score 230, e.g., a score based at least in part on the harm caused to the environment that can be attributed to user 224, by an amount that is based at least in part on the impact caused by producing raw and/or manufactured materials used to make at least the first part of product 102.

In an exemplary embodiment, the production phase potential-ecological-impact quantification can be added to the ecological-impact score 230 in response to associating product 102 with product list 226. For example, when LCM 118 receives a signal from a device such as device 302 that indicates that user 300 obtained product 102, LCM 118 can add product 102 to product list 226 and access product information repository 202 to find a production phase potential-ecological-impact quantification. In this example, LCM 118 can find a potential-ecological-impact quantification that is based at least in part on the ecological impact caused by gathering raw and/or manufactured materials, e.g., 10 impact points, and LCM 118 can add the production phase potential-ecological-impact quantification to ecological-impact score 230.

In a specific example, suppose product 102 is a blender. In this example, the manufacturer of the blender could have provided a components list to ecological service provider 112. In this example, an analysis of the blender can be performed that estimates the ecological impact caused by gathering raw and/or manufactured materials used to create the blender, the scarcity of the materials and/or, the energy used to assemble the blender, etc., to generate the production phase potential-ecological-impact quantification for the blender.

Sometime later, user 300 may purchase the blender and associate it with his or her user account 224. In this example, lifecycle module 118 can receive a signal indicating that user 300 purchased the blender and update product list 226 to indicate that he or she purchased the blender, e.g., by adding device-readable identifier 314 to product list 226 along with, for example, a timestamp indicative of the time the blender was added to product list 226. In this example, lifecycle module 118 can also search production phase quantification table 216 to obtain information used to adjust ecological-impact score 230 associated with user account 224. In this example, lifecycle module 118 can use device-readable identifier 314 to search production phase quantification table 216 and find production phase potential-ecological-impact quantification based on the production of raw and/or manufactured materials for the blender and add it to ecological-impact score 230.

Continuing with the description of FIG. 9A, operation 904 shows adjusting the ecological-impact score based on estimated ecological impact due to manufacturing at least the first portion of the physical product. For example, in an exemplary embodiment, a production phase potential-ecological-impact quantification can be based on the CO₂e emitted by manufacturer 104 to manufacture product 102 and/or the hazardous materials generated by manufacturer 104 to manufacture product 102. In this example, energy consumption information obtained from manufacturer 104 could be used along with information about the source of the energy to calculate the amount of CO₂e emitted to manufacture product 102.

In a specific example, suppose product 102 is a laptop. In this example, the manufacturer of the laptop could have generated energy consumption information for a plant that assembles laptops. In this example, an analysis can be performed that determines the amount of energy used to product a single laptop and the source of that energy. From this information the amount of CO₂e emitted to manufacture the laptop can be estimated and used to generate a production potential-ecological-impact quantification, e.g., 10 impact points, for product 102.

Sometime later, user 300 may purchase the laptop and associate it with his or her user account 224. For example, device 302 can scan the laptop to obtain a device-readable indicator, which can be sent via network 100 to LCM 118. Lifecycle module 118 can receive the signal and update product list 226 to indicate that user 300 purchased the laptop. In this example, lifecycle module 118 can also search production quantification table 216 to obtain a production phase potential-ecological-impact quantification that can be based on the damage caused to the environment by manufacturing the laptop and add it to ecological-impact score 230.

Continuing with the description of FIG. 9A, operation 906 shows adjusting the ecological-impact score based on estimated ecological impact due to transporting at least the first portion of the physical product. For example, in at least one exemplary embodiment, a use phase potential-ecological-impact quantification can be based on average amount of CO₂e emitted to transport product 102 from the location of manufacturer 104 to retailer 106 or product consumption location 108 and/or the amount of CO₂e emitted to store product 102 prior to purchase, e.g., in the instance that product 102 needs to be refrigerated, frozen, etc.

Lifecycle module 118 in this exemplary embodiment can be configured to adjust estimated-ecological-impact score 230 by an amount that is based at least in part on a use phase potential-ecological-impact quantification in response to associating product 102 with product list 226. In this example, LCM 118 can use device-readable indicator 314 to search use phase quantification table 218 for a use phase potential-ecological-impact quantification that is based on transporting product 102. In this example LCM 118 can find such a quantification and add it to ecological-impact score 230.

In a specific example, suppose product 102 is a six pack of beer. In this example, the manufacturer of the six pack of beer could provide information about the average distance the six pack travels to reach a consumer and the mode of transportation. This information could be used to determine how much CO₂e is emitted to transport the six pack of beer and used to generate a potential-ecological-impact quantification.

Sometime later, user 300 may purchase the six pack of beer and associate it with his or her user account 224. For example, user 300 may use his or her credit card, which can be linked to user account 224. The credit card transaction can include a device-readable indicator, which can be sent via network 100 to LCM 118. Lifecycle module 118 can receive the signal and update product list 226 to indicate that he or she purchased the six pack of beer. In this example, lifecycle module 118 can also use the device-readable identifier to search for potential-ecological impact quantifications and use them to adjust ecological-impact score 230 associated with user account 224. In this example, lifecycle module 118 can a transportation potential-ecological-impact quantification associated with the six pack of beer that takes into account ecological harm caused by transporting product 102 and add it to ecological-impact score 230.

Continuing with the description of FIG. 9A, operation 908 shows adjusting the ecological-impact score based on estimated ecological impact due to using at least the first portion of the physical product. For example, in at least one exemplary embodiment, a potential-ecological-impact quantification can take into account the amount of CO₂e emitted to use product 102. In this example, energy consumption information obtained from manufacturer 104 could indicate the average amount of power product 102 uses while in operation and use this information to generate a potential-ecological-impact quantification.

In an embodiment where the potential-ecological-impact quantification is time oriented, e.g., calculated for the life of product 102, portions of the value can be added to ecological-impact score 230 over time. For example, if the quantification was 10 points and the expected lifecycle is 5 years, 2 points can be added every year to ecological-impact score 230. In this example, the time product 102 was purchased can be stored in product list 226 along with information indicating that additional points need to be added to ecological-impact score 230 at predetermined time points. LCM 118 can be configured to check the product list 226 at the predetermined time points and update ecological-impact score 230.

In a specific example, suppose product 102 is an alarm clock radio. In this example, the manufacturer of the alarm clock radio could have generated energy consumption information for the alarm clock radio that identifies an estimated amount of power the alarm clock radio will use over the course of its life. In this example, an analysis can be performed that determines the amount of energy the alarm clock radio will consume over its expected lifetime and information that identifies the typical amount of CO₂e emitted to generate the determined amount of energy. This information could be used to generate a use potential-ecological-impact quantification for product 102.

Sometime later, user 300 may purchase the alarm clock radio and associate it with his or her user account 224. In this example, lifecycle module 340 can receive a signal indicating that user 300 purchased the alarm clock radio and update a local copy of product list 226 to indicate that he or she purchased the alarm clock radio. The local copy of user account 224 can subsequently synchronize with user account 224 in database 114. In this example, LCM 340 can also send device-readable indicator 314 along with a request for potential-ecological impact quantifications associated with the alarm clock radio to ecological service provider 112 via network 100. Lifecycle module 118 can receive the request and use device-readable indicator 314 to search for potential-ecological-impact quantification for the alarm clock radio. LCM 118 in this example can find a potential-ecological-impact quantification that is based at least on using the alarm clock radio and adjust ecological-impact score 230 associated with user account 224.

Continuing with the description of FIG. 9A, operation 910 shows converting the ecological-impact score to a monetary value. In an exemplary embodiment, and turning to FIG. 2, ecological-impact score 230 can be converted into a price by lifecycle module 118. For example, price table 244 can store information such as the market price of rare materials, the market price of CO₂e, the market cost of disposing hazardous waste, etc. In this example, LCM 118 can be configured to use the raw data stored in production information repository 202 and price table 244 to generate potential-ecological-impact quantifications in a currency, e.g., dollars, which in turn can be used to generate a ecological-impact score in a currency.

For example, price table 244 can include the current price of carbon on a carbon market, the current price of a kilowatt-hour, the current price of rare materials used to create product 102, etc. For example, an online market such as the Chicago Climate Exchange® maintains a CO₂e emissions trading system for emissions and offsets. In an exemplary embodiment, price table 244 can be updated at predetermined time periods, e.g., once a day, week, month, year, with the current market value of a metric ton of CO₂e. Similarly, the price of a kilowatt-hour and the price of rare-materials used to create product 102 can also be stored in price table 244. In this example embodiment, the data used to generate a potential-ecological-impact quantification can also be used to generate a price.

In a specific example, suppose that product 102 is a car, and the amount of energy needed to manufacture the car could be estimated to be about 18,110 kilograms of CO₂e. This information could be stored in CO₂e table 206 and used to generate a potential-ecological-impact quantification that in dollars using price per metric ton of CO₂e information. For example, the price of a metric ton of CO₂e could be $1.03 per metric ton; thus, the price associated with this potential-ecological-impact quantification could be calculated to be approximately $18.65. The $18.65 could be added to an ecological-impact score that is displayed in dollars, which could also be stored in ecological-impact score 230.

Continuing with the description of FIG. 9A, operation 912 shows adjusting the ecological-impact score based on a carbon-offset associated with the user account. For example, in an embodiment the ecological-impact score can be adjusted, e.g., reduced, by an amount based on carbon-offsets obtained by user 300 and associated with user account 224. In this example, a carbon-offset can be associated with a potential-ecological-impact quantification, i.e., a negative value, which could be added to ecological-impact-score 230 to reduce the score. For example, in a specific example, a carbon offset could to plant an acre of trees, which may store about 2.6 tons of CO₂e each year. In this example, 2.6 metric tons of CO₂e can be used to generate a potential-ecological-impact quantification for the offset project.

For example, device 302 can include user interface 310, which can display list of carbon offsets for purchase. For example, user interface 310 can render a web-browser that can download a webpage associated with a carbon market. The web-page can itemize a number of organizations that engage in projects to reduce the CO₂ by planting trees or increasing the amount of other natural carbon sinks. Each organization can list the projects they are involved in and a price for reducing a metric ton of CO₂ can be listed. In this example, user 300 can select one or more of the listed organizations and pay a fee to the organization and receive a carbon offset. In this example, device 302 can send one or more packets of information indicative of the offset to lifecycle module 118. LCM 118 can lookup the offset; obtain a potential-ecological-impact quantification associated with the offset; and reduce ecological-impact score 230.

Referring now to operation 914, it shows associating the user account with a reward based on the ecological-impact score. For example, in an embodiment, LCM 118 can associate rewards with user account 224 based on ecological-impact score 230 of user account 244. Social networking module 116 can read reward/penalty user information 228 and generate one or more web-pages that include information based on the reward/penalty user information 228 such as coupons, trophies, etc.

In an exemplary embodiment, a list of rewards and ecological-impact scores could be stored in reward/penalty table 248 and LCM 118 can associate rewards with user accounts based on a user's ecological-impact score. For example, lifecycle module 118 can be configured to compare ecological-impact score 230 to reward/penalty table 248 and determine if a reward is available for user 300 based on his or her score. In the instance that a reward is available, lifecycle module 118 can be configured to add the reward to user reward/penalty user information 228. The reward can then be displayed by a web-page, send to the device 302 in an email or a text message, printed by user 300, etc.

In an exemplary embodiment, reward/penalty table 248 can include at least one column of rewards corresponding to columns of estimated-ecological-impact score thresholds. In a specific example, a reward could be a coupon for a new mobile device, or a restaurant, or free tickets to a sporting event, etc. In another specific example, the reward can be associated with the products associated with the user account. For example, if the user has a toaster oven, the reward could be for a new version of the toaster oven. The score threshold can be based on an absolute ecological-impact score or it could be based on the rate ecological-impact score increases over a time period, e.g., week, month, year, etc. For example, if user 300 keeps his or her score from increasing at a rate less than a threshold for a period of time, a reward could be granted. In another embodiment, the score threshold can be based on the rate that other user's scores increase over a time period or a standard set by a group.

In a specific example, suppose lifecycle module 118 accesses reward/penalty table 248 periodically, e.g., one a day, week, month, etc., to update rewards for user accounts such as user account 224. In this example, lifecycle module 118 can use ecological-impact score 230 to determine that user 300 has keep his or her score from increasing over a threshold, e.g., 10 impact points per week, during the past month and determines that this threshold is associated with a pair of free tickets to a movie theater. In this example, lifecycle module 118 can add the movie tickets to reward/penalty user information 228. Social networking module 116 can read the reward/penalty user information 228 and generate one or more web-pages that include an indicator for the movie tickets and send the one or more web-pages to device 302.

Referring now to operation 916, it shows associating the user account with a reward in response to determining that the physical product has been associated with the user account for more than a threshold amount of time. For example, in an exemplary embodiment, the amount of time that product 102 has been associated with user account 224 can be used to associate rewards with user account 224. For example, lifecycle module 118 can be configured to use the length of time a product has been stored in product list 226 to determine whether to associate a reward with user account 224. In this example reward/penalty table 248 can include a column that includes length of time thresholds. Periodically, LCM 118 can check the reward/penalty table 248 and use length of time information associated with product list 226 to search for rewards. In the instance that a reward is found, lifecycle module 118 can add the reward to reward/penalty user information 228. In a specific example, email module 120 can read the reward/penalty user information 228 and generate information that allows user to create a signature block that includes the indicator for the reward. In this example, emails composed by user 300 can include an icon indicative of the reward.

In another specific example, suppose user 300 has had the same cellular phone associated with his or her user account for a threshold length of time, e.g., 5 years, 7, years, etc. This information could be stored in product list 226. In this example, lifecycle module 118 can compare the length of time user 300 has had the cellular phone to thresholds in reward/penalty table 248 to determine if any rewards are available. In this specific example, a reward such as a trophy, i.e., an icon of a trophy that symbolizes the user's greenness, could be associated with a threshold length of time of 3 years. In this example, lifecycle module 118 can determine that user 300 has had the cellular phone for 5 years by determining the length of time user 300 has had cellular phone to the threshold; select information indicative of the reward; and associate the information with user account 224 by storing information indicative of the reward within reward/penalty user information 228. User 300 can be allowed to embed a graphic indicative of the reward in his or her email signature block, display it on the desktop of his or her operating system, display it on the background of his or her mobile device, display it on his or her social networking webpage, etc.

Continuing with the description of FIG. 9A, operation 918 illustrates associating the user account with a reward in response to a selection of the first mode of disposing of at least the first portion of the physical product. For example, in an exemplary embodiment, a selection of the first mode of describing at least the first part of product 102 can be used to associate a reward with user account 224. For example, reward/penalty table 248 can include information such as a list of rewards and a list of disposal modes for product 102. In this example, a reward, e.g., an icon of a trophy, can be associated with the first mode of disposing of at least the first portion of product 102. In this example, LCM 118 can be configured to access reward/penalty table 248 in response to receiving a signal indicative of a selection of the first mode of disposing at least the first portion of product 102 and associate the reward, e.g., an icon of a trophy, etc., with user account 224. For example, LCM 118 can be configured to send a signal indicative of the reward to reward/penalty user information 228.

In a specific example, the first mode of disposing of at least the first portion of product 102 can include recycling product 102, e.g., a microwave. In this example, microwave could be associated with multiple disposal modes, such as, for example, landfilling, incinerating, and recycling. In this example, recycling could be a favored disposal mode and reward/penalty table 248 can include a column for the microwave that indicates that a free month of Internet service is offered for users that select the recycling disposal mode (for example, the recycling facility may be difficult to get to.)

In this example, user 300 may decide to dispose of his microwave and open a menu on device 302 that includes an option for disposing of products. User interface 310 could receive a signal indicative of a selection of the option to dispose of products and LCM 340 could cause RFID reader 312 to emit a signal. The microwave could response with its device-readable indicator and LCM 340 could cause user interface 310 to render an image that includes text such as “Do you want to dispose of microwave?” User interface 310 could receive a signal indicative of a “yes” and send one or more packets of information indicative of the device-readable indicator for the microwave and a request for disposal mode options to ecological service provider 112 via network 100. LCM 118 could receive the request and search disposal mode identifier table 214 (which could be for the microwave in this example) and obtain disposal mode identifiers for landfilling, incinerating, and recycling. In addition LCM 118 can search reward/penalty table 248 and determine that a free month of Internet service is offered for users that select the recycling disposal mode. In this example, LCM 118 can format a message that includes the aforementioned information (disposal mode identifiers and reward information) and send the message to LCM 340 via network 100.

LCM 340 can receive the message and cause user interface 310 to display information associated with the three disposal modes and information that identifies the reward. In this example, user interface 310 can receive information indicative of the selection of the recycling mode and cause a disposal-mode-identifier for recycling, i.e., instructions on how to get to the recycling facility, to be displayed. User 300 can transport the microwave to the disposal facility and recycle it. An agent of the disposal facility can use a computer system (similar to device 302) to scan microwave and send a message that includes a unique serial number for the recycling facility, an identifier for user account 224, and the device-readable indicator for the microwave to ecological service provider 112. LCM 118 can receive the message, user the serial number to confirm that user 300 in fact recycled the microwave and associate the reward with reward/penalty user information 228. In this example, ecological service provider 112 may be affiliated with the Internet provider (not shown) used by user 300 and can send a signal to the Internet provider, which indicates that the user 300 is to receive a free month of Internet service.

Referring now to FIG. 9B, it illustrates additional operations 920-930, which can be executed along with one or more of the operations illustrated in FIGS. 9A and/or 9C and are illustrated in FIG. 9B for clarity purposes.

As shown by operation 920, the operational procedure can include an operation for associating the user account with a reward in response to the output of an intensity-of-use indicator associated with at least the first portion of the physical product. For example, and turning to FIG. 3, in an exemplary embodiment product 102 can include an intensity-of-use indicator 322. In this example, intensity-of-use indicator 322 can output information that can be used to infer how efficiently product 102 is being used.

In an exemplary embodiment, device 302 can receive the output from intensity-of-use indicator 322 and send it to LCM 340. In this example, LCM 340 can be configured to access a local copy of reward/penalty table 248 and search it using, for example, the output from intensity-of-use indicator 322, the time product 102 has been associated with user account 224, and device readable indicator 314. In this example, reward/penalty table 248 may include a list of rewards associated with product 102 and various outputs from intensity-of-use indicator 322. In this example, LCM 340 can find a reward associated with the output from intensity-of-use indicator 322 and associate the reward, e.g., an coupon, etc., with user account 224. For example, LCM 340 can be configured to send a signal indicative of the reward to the local copy of reward/penalty user information 228. Device 302 can synchronize with system 106 and user account 224 can be updated to show that the reward has been added to reward/penalty user information 228.

In a specific example, suppose that product 102 is a snow blower and includes a sensor that monitors the amount of time that it is active. In this example suppose manufacturer 104 has determined the amount of time per a time period, e.g., week, month, season, that reflects the optimum usage for the snow blower. For example, suppose that the optimum amount of time could be obtained by monitoring how much time a snow blower is active in the instance that it is used to remove snow from three moderately sized driveways over the winter. This amount of time could be stored in reward/penalty table 248 as a threshold. In the instance that the sensor indicates that the snow blower has been used more than the average amount of time it would take to remove snow from three moderately sized driveways user account 224 could be associated with a reward.

In this example, the snow blower could be configured to send the output from its sensor to device 302 and/or ecological service provider 112 via network 100. In one example, device 302 could receive the value and a device-readable identifier indicative of the snow blower and send a message including the device-readable identifier and the output from the sensor to LCM 118 and a request to update rewards/penalties. LCM 118 can receive the message and determine that request is to update reward/penalties based on output from an intensity-of-use indicator. LCM 118 can use the device-readable identifier to open a table in reward/penalty table 248 for the snow blower and use the output from the intensity-of-use indicator to compare the amount of operational time during the last week to the threshold. In the instance that the amount of active time is greater than the threshold, LCM 118 can copy information indicative of an associated reward into reward/penalty user information 228.

In another example, suppose the snow blower includes a user interface that allows different users to indicate that they are using the snow blower. In this example, the intensity-of-use indicator could be the number of different users that use the snow blower within a set period of time, e.g., a day, a week, etc. In this example, suppose the threshold for a reward is that five different users need to use the snow blower within the set period of time. In this example, suppose that the optimum number of users for the snow blower was obtained by manufacturer by monitoring how many different users can use a snow blower without being greatly inconvenienced by having to wait for a turn. This number of users could be stored in reward/penalty table 248 as a threshold. In the instance that the sensor indicates that the snow blower has been used by more than the threshold number of users user account 224 (the account of the owner) and/or the accounts of the other users could be associated with a reward.

Continuing with the description of FIG. 9B, operation 922 shows associating the user account with a reward based on a determination that the physical product was associated with the user account for longer than a threshold amount of time prior to the selection of the first disposal mode for disposing of at least the first portion of the physical product, wherein the threshold amount of time is based at least in part on disposal behavior associated with a group of users. For example, in an exemplary embodiment, a selection of the first mode of describing at least the first part of product 102 can be used to associate a reward with user account 224. For example, reward/penalty table 248 can include information such as a list of rewards and a disposal threshold for product 102, e.g., an amount of time measured from when a product is associated with product list 226 to when a selection of a disposal mode is made. In this example, the disposal threshold can be set by monitoring how a group of users, e.g., friends of user 300 stored in friend list 232 or a group 250, have previously disposed of similar products. For example, if the average length of time that a product is owned by friends is 1 year, this value can be used by reward/penalty table 248 as the threshold. In this example, a positive reward can be associated with user account 224 in the instance that user 300 disposed of product 102 after the length of time stored in reward/penalty table 248 or user account 224 could be associated with a negative reward if user 300 disposed of product 102 before the length of time expires in reward/penalty table 248.

In an exemplary embodiment, LCM 118 can maintain a group table for the group that user 300 belongs to, e.g., group 250. When LCM 118 updates product list 226 to indicate that a product in product list 226 has been disposed, LCM 118 can obtain a timestamp of when product 120 was associated with user account 224 and use the timestamp and the current time to calculate how long product 102 was associated with user account 224. LCM 118 can lookup user account 224 to determine if user account is a member of a group in group profile store 240 and add use the length of time that product 102 was associated with user account 224 to update a disposal threshold for this type of product.

In a specific example, suppose user 300 is a member of a group and would like to dispose of product 102, which could be a book. In response to a signal indicating that user 300 wishes to dispose of the book, LCM 118 can update product list 226 to indicate that product 102 has been disposed of according to the first disposal mode and determine how long product 102 was associated with user account 224. In this example, LCM 118 can check reward/penalty table 248 and compare the length of time product 102 was associated with user account 224 to a disposal threshold that was set based on how other members of the group have kept books before disposing of them. In this example, user 300 may have had product 102 longer than the disposal threshold stored in reward/penalty table 248 and LCM 118 can select a reward associated with the disposal threshold. LCM 118 can then send a signal indicative of the reward to reward/penalty user information 228. Reward/penalty user information 228 can receive the reward and update reward/penalty user information 228.

Referring now to operation 924, it shows associating the user account with a reward based on a determination that the physical product was associated with the user account for longer than a threshold amount of time prior to the selection of the first disposal mode for disposing of at least the first portion of the physical product, wherein the threshold amount of time is set by a group. Similar to operation 922, in an exemplary embodiment, a selection of the first mode of disposing of at least the first part of product 102 can be used to associate a reward with user account 224. In this example, reward/penalty table 248 can include information such as a list of rewards and a disposal timetable for product 102 that is set by a group such as a group of friends, product manufacturer 104, and/or an organization. In an exemplary embodiment, the timetable can be a period of time measures from when a product is associated with product list 226 to when it is marked as disposed of in product list 226. In this example, a positive reward can be associated with user account 224 in the instance that user 300 disposed of product 102 after the length of time stored in reward/penalty table 248 or user account 224 could be associated with a negative reward if user 300 disposed of product 102 before the length of time expires in reward/penalty table 248.

In an exemplary embodiment, LCM 118 can maintain a group table for the group that user 300 belongs to, e.g., group 250. In this exemplary embodiment, social networking module 116 can be configured to generate one or more web-pages that allow a user to form a group. In response to the formation of group 250 LCM 118 can associate user account 224 with group 250 by storing information in user account 224. Other members can join the group and LCM 118 can add group identifiers for group 250 to user accounts for these users. Social networking module 116 can be configured to generate one or more web-pages that allow the members of the group to set disposal thresholds. These disposal thresholds can then be saved in group 250 and used by reward/penalty table 248 in exemplary embodiments.

For example, in response to a signal indicating that user 300 wishes to dispose of product 102, LCM 118 can update product list 226 to indicate that product 102 was disposed of and determine how long product 102 was associated with user account 224. In this example, LCM 118 can check reward/penalty table 248 and compare the length of time product 102 was associated with user account 224 to the disposal threshold that was set by the members of the group that user 300 belongs to. In this example, user 300 may have had product 102 longer than the disposal threshold stored in reward/penalty table 248; LCM 118 can select a reward associated with the disposal threshold; and send a signal indicative of the reward to reward/penalty user information 228. Reward/penalty user information 228 can receive the reward and update reward/penalty user information 228.

Continuing with the description of FIG. 9B, operation 926 shows displaying information that is at least based in part on the ecological-impact score received from a media distribution center and/or a social networking server. For example, social networking module 116 can be configured to display information that is at least based in part on ecological-impact score 230. For example, social networking module 116 can obtain ecological-impact scores associated with the user accounts in user account repository 222 and compile different statistics based on the scores and store the information in ecological statistics table 236. For example, a graph that uses the estimated-ecological-impact score as a data point can be generated and displayed when user 300 wishes to compare his or her ecological-impact score to the average score of all of his or her friends. In this specific example, social networking module 116 can generate one or more web-pages that allow user 300 to filter data so he or she can perceive a score that is the average of the ecological-impact score of all of the friends stored in friend list 232.

In another specific example, social networking module 116 can obtain metadata for the estimated-ecological-impact scores that describe how the scores were calculated and store this information in ecological statistics table 236. In this example, the web-pages generated by social networking module 116 can include logic that allows a user to toggle different filters on the data in order to view his or her score per month, per week, per year, etc.

In another specific example, media distribution center 150, which could be maintained by a third party, can disseminate information that is at least based in part on the ecological-impact score to users. For example, media distribution center 150 could be an organization that allows users to create Internet-based journals, e.g., blogs. In this example, the blog could receive the ecological-impact score from, for example, device 302 or system 106. The ecological-impact score could then be stored within a webpage or document that is accessible via the blog. In another specific example, media distribution center 150 could have a short message service server that can broadcast information that is at least based in part on the ecological-impact score to users in a text message. In another specific example, media distribution center 150 could include an email server that is configured to generate emails that include information that is at least based in part on the ecological-impact score and send them to users. In yet another specific example, media distribution center 150 could disseminate information that is at least based in part on the ecological-impact score over a radio signal, e.g., a radio station, via a news letter, and/or via television.

In addition to operation 926, FIG. 9B also shows operation 928, which illustrates adjusting the ecological-impact score based on an output from an intensity-of-use indicator associated with at least the first portion of the physical product. For example, ecological-impact score 230 can be based on how intensely product 102 has been used while product is and/or was associated with user account 224. For example, the more efficiently product 102 was used and/or is being used can be used to reduce the value added to ecological-impact score 230. Conversely, the more inefficiently product 102 is being used and/or was used can be used to increase ecological-impact score 230.

In an exemplary embodiment, lifecycle module 118 can be configured to adjust ecological-impact score 230 based on the output from an intensity-of-use indicator 322. For example, LCM 118 can include quantification adjustment table 242, which can include a table for product 102 that contains a column for the output of intensity-of-use indicator 322; and adjustment constants, which can be multiplied with and/or added to ecological-impact scores or to as potential-ecological-impact quantifications (in an exemplary embodiment) before the potential-ecological-impact quantifications are added to ecological-impact score 230.

In a specific example, suppose product 102 is a car and user 300 decides to dispose of the car by reselling it. In this example, lifecycle module 118 may receive a signal indicating that user 300 is going to sell the car to, for example, user 318. User 300 may input the number of miles on the odometer into device 302 and send a message including the mileage and an indication that car is being resold to Lifecycle module 118 via network 100. LCM 118 may receive the message and compare the mileage to the number of miles that had been driven when user 300 associated product with his or her user account 224 (such information could be stored in product list 226) and compare a value that reflects how much the car has been used. In this example, lifecycle module 118 can be configured access quantification adjustment table 242 and use a device-readable indicator for the car to select a table for the car and use the value to search for an adjustment-quantification. In this specific example, suppose potential-ecological-impact quantification for reselling the car is 0; however, user 300 has inefficiently used the car, i.e., the mileage is low, which indicates that user 300 probably did not need to purchase a car. In this example, quantification adjustment table 242 may indicate that 5 points should be added to ecological-impact score 230 in addition to the 0 points due to the selection of the resell potential-ecological-impact quantification. LCM 118 can obtain the value (5 impact points in this example) and add it to the potential-ecological-impact quantification (0 in this example) and then add the total (5 impact points) to ecological-impact score 230.

Turning now to operation 930, it shows adjusting the ecological-impact score based on the first potential-ecological-impact quantification in response to a selection of the first mode of disposing of at least the first portion of the physical product. For example, and referring to FIG. 3, lifecycle module 118 can receive a message from device 302 indicating that user 300 selected the first mode of disposing of at least the first portion of product 102. The message can indicate, for example, user account 224, device-readable indicator 314, and a selection of a disposal mode identifier stored in disposal mode identifier table 214. In this example, LCM 118 can receive the message and use device-readable indicator 314 and a selection of a disposal mode identifier stored in disposal mode identifier table 214 to find a potential-ecological-impact quantification associated with the first mode, e.g., the first potential-ecological-impact quantification described above, in disposal phase quantification table 220. LCM 118 can then be configured to add a value that is based at least in part on the first potential-ecological-impact quantification to ecological-impact score 230.

In a specific example, suppose product 102 is an air filter for a car. In this example, the air filter may be used up and needs to be replaced. A user, e.g., a mechanic, may receive a user account identifier from user 300 for user account 224 and scan the air filter to obtain a device-readable indicator for the air filter. In this example embodiment, suppose the air filter has a device readable indicator encoded within a barcode and the mechanic can extract the indicator using a barcode reader attached to a computer system. In this specific example, a user interface could display a menu of options that includes a menu item such as “dispose of product.” The mechanic could select the menu item and the computer system could send a message to LCM 118 that includes information identifying user account 224 and the device-readable indicator for the air filter. In this example, LCM 118 can search disposal mode identifier table 214 for disposal modes associated with the device-readable indicator and obtain first disposal-mode identifier, which could be sent back to the computer system via network 100 and then displayed by the computer's user interface, e.g., a display. The mechanic could select the first disposal mode, which could be landfill disposal mode, and a message indicative of the mechanic's selection, which could include information identifying the user account and the device-readable identifier can be sent to ecological impact provider 112 via network 100. Network adapter 122 can receive the message and send the message to lifecycle module 118. Lifecycle module 118 can process the message and locate a first potential-ecological-impact quantification, e.g., 5 impact points, that is associated with the device-readable identifier and the selected disposal mode. Lifecycle module 118 can then access ecological-impact score 230 and add 5 impact points to it.

Referring to FIG. 9C, it illustrates additional operations 932-944, which can be performed in conjunction with one or more operations depicted in FIGS. 9A and/or 9B.

Turning now to operation 932, it shows displaying a user interface, wherein the user interface includes information indicating a length of time the physical product has been associated with the user account. For example, and referring to FIG. 3, device 302, which can be a mobile phone, can include user interface 310, e.g., a touch display. In this example, user interface 310 can render a bitmap indicative of a user interface for user account 224. The user interface for user account 224 in this example can include information such as the length of time product 102 has been associated with user account 224.

In a specific example, suppose device 302 includes client lifecycle module 340 that is configured to access database 114 via network 100. In this specific example, user 300 could access LCM 340 and select a menu icon such as “show product list.” In response to the selection, LCM 340 could send one or more packets of information to LCM 118, which can access database 114 to obtain user account information such as product list 226. In this specific example, product list 226 can store date information for each product that identifies the time that the product was stored in product list 226. LCM 118 can send one or more packets indicative of product list 226 back to device 302. LCM 340 can receive information indicative of product list 226 and use the'date information for product 102 and the current date to calculate a length of time product 102 has been associated with user account 224. LCM 340 can then generate a bitmap indicative of a user interface for a user account associated with user 300 that includes information such as the length of time product 102 has been associated with the user account.

Continuing with the description of FIG. 9C, operation 934 shows displaying a user interface, wherein the user interface includes information indicating a number of times physical products associated with the user account have been disposed of by a recycle mode of disposal. For example, and referring to FIG. 3, device 302, which can be a personal computer, can include user interface 310, e.g., a LCD display, keyboard, and mouse. In this example, user interface 310 can be configured to render a bitmap indicative of a user interface for user account 224 associated with user 300 that includes information such as the number of times the user has disposed of associated products by recycling them. For example, product list 226 can include information such as a list of products that has been associated with user account 224 and the selected disposal method for each product that has been disposed of. The information in product list 226 can then be used to generate a user interface showing the number times products associated with user account 224 have been disposed of by a recycle mode of disposal.

In a specific example embodiment, suppose device 302 accesses a web-page generated by social networking module 116 that allows user 300 to interact with his or her user account 224. In this example, a web-browser can generate a bitmap indicative of a menu that allows user 300 to select a menu icon for “displaying number of times recycle mode has been selected.” In response to a selection of the icon, one or more packets of information can be sent to social networking module 116, which can route the input to LCM 118. LCM 118 can access product list 226 and filter the list based on information in a column that indicates recycle disposal mode and determine the number of times such a disposal mode was selected. LCM 118 can then send the result to social networking module 116, which can send the result back to the web-browser running on device 302. The web-browser can then generate a bitmap that includes the number of times a recycle disposal mode was selected and cause the bitmap to be rendered on a display.

Referring to operation 936, it shows displaying a user interface, wherein the user interface includes information indicating a number of times physical products associated with the user account have been disposed of by a resell mode of disposal. For example, and referring to FIG. 3, device 302, which can be laptop, can include user interface 310, e.g., a LCD display, keyboard, and touch interface. In this example, user interface 310 can be configured to render a bitmap indicative of a user interface for user account 224 associated with user 300 that includes information such as the number of times the user has disposed of associated products by reselling them. For example, product list 226 can include information such as a list of products that has been associated with user account 224 and the selected disposal method for each product that has been disposed of. The information in product list 226 can then be used to generate a user interface showing the number times products associated with user account 224 have been disposed of by a resell mode of disposal.

In this exemplary embodiment, suppose device 302 includes LCM 340 and client database 342. In this example, LCM 340 can generate a bitmap indicative of a menu that allows user 300 to select a menu icon for “displaying number of times resell mode has been selected.” In this example, in response to a selection of the icon, LCM 340 can access client database 342 and search a local copy of user account 224. For example, a copy of user account 224 can be cached on device 302 and used when, for example, device 302 does not have access to network 100. In this example, LCM 340 can access local copy of product list 226 and filter the list based on information in a column that indicates resell disposal mode and determine the number of times such a disposal mode was selected. LCM 340 can then generate a bitmap that includes the number of times a resell disposal mode was selected and cause the bitmap to be rendered on a display.

Referring to operation 938, it shows displaying a user interface, wherein the user interface includes information indicating a number of times physical products associated with the user account have been disposed of by a compost mode and/or a sequestration mode of disposal. For example, and referring to FIG. 3, device 302, which can be mobile phone, can include user interface 310, e.g., a touch interface. In this example, user interface 310 can be configured to render a bitmap indicative of a user interface for user account 224 associated with user 300 that includes information such as the number of times the user has disposed of associated products by composting them and/or by causing product 102 or a portion thereof to be sequestered. For example, product list 226 can include information such as a list of products that have been associated with user account 224 and the selected disposal method for each product that has been disposed of. The information in product list 226 can then be used to generate a user interface showing the number times products associated with user account 224 have been disposed of by a compost mode of disposal and/or a sequesteration mode of disposal.

In this exemplary embodiment, suppose device 302 includes LCM 340 and client database 342. In this example, LCM 340 can generate a bitmap indicative of a menu that allows user 300 to select a menu icon for “displaying number of times compost disposal mode has been selected.” In this example, in response to a selection of the icon, LCM 340 can access client database 342 and search a local copy of user account 224. For example, in this embodiment a copy of user account 224 can be cached on device 302 and LCM 340 can be configured to first search this copy and then send a request to LCM 118 if the information is not found within client database 342. In this example, LCM 340 can first access a local copy of product list 226 and filter the list based on information in a column that indicates whether products were disposed of according to a composting disposal mode and determine the number of times such a disposal mode was selected. LCM 340 can then generate a bitmap that includes the number of times a composting disposal mode was selected and cause the bitmap to be rendered on a display.

Referring to operation 940, it shows displaying a user interface, wherein the user interface includes information indicating a number of times physical products associated with the user account have been disposed of by a landfill mode and/or ocean floor dispersal mode of disposal. For example, and referring to FIG. 3, device 302, which can be mobile phone, can include user interface 310, e.g., a touch interface. In this example, user interface 310 can be configured to render a bitmap indicative of a user interface for user account 224 associated with user 300 that includes information such as the number of times the user has disposed of associated products by sending the products to a landfill and/or to a facility that will dispose of products by depositing them in the ocean. For example, product list 226 can include information such as a list of products that has been associated with user account 224 and the selected disposal method for each product that has been disposed of. The information in product list 226 can then be used to generate a user interface showing the number times products associated with user account 224 have been disposed of by a landfill mode of disposal and/or by sending them to a facility that will depositing products on the bottom of the ocean.

For example, suppose device 302 includes a client lifecycle module 340 and accesses database 114 via network 100. In this specific example, user 300 could access LCM 340 a select a menu icon such as “show number of times landfill disposal mode was selected.” In response, LCM 340 could send one or more packets of information to LCM 118, which can access database 114 to obtain user account information such as product list 226. In this specific example, product list can store a product history and include a column of information that indicates a disposal mode that was selected for each product. LCM 118 can filter the information based on a landfill identifier and obtain the number of times user 300 landfilled products. LCM 118 can send one or more packets indicative of this information back to device 302. LCM 340 can receive information and generate a bitmap indicative of a user interface for user account 224 associated with user 300 that includes information such as the number of times user 300 has caused products to be sent to a landfill and cause the bitmap to be rendered on a display.

Referring to operation 942, it shows displaying a user interface, wherein the user interface includes information indicating a number of times physical products associated with the user account have been disposed of by an incineration mode and/or an evaporation mode of disposal. For example, and referring to FIG. 3, device 302, which can be mobile phone, can include user interface 310, e.g., a touch interface. In this example, user interface 310 can be configured to render a bitmap indicative of a user interface for user account 224 associated with user 300 that includes information such as the number of times the user has disposed of associated products by sending the products to an incineration facility and/or to a facility that will evaporate products. For example, product list 226 can include information such as a list of products that has been associated with user account 224 and the selected disposal method for each product that has been disposed of. The information in product list 226 can then be used to generate a user interface showing the number times products associated with user account 224 have been disposed of by an incineration mode of disposal and/or an evaporation mode of disposal.

For example, suppose device 302 includes a client lifecycle module 340 and accesses database 114 via network 100. In this specific example, user 300 could access LCM 340 a select a menu icon such as “show number of times incineration disposal mode was selected.” In response, LCM 340 could send one or more packets of information to LCM 118, which can access database 114 to obtain user account information such as product list 226. In this specific example, product list can store a product history and include a column of information that indicates a disposal mode that was selected for each product. LCM 118 can filter the information based on an incineration identifier and obtain the number of times user 300 incinerated products. LCM 118 can send one or more packets indicative of this information back to device 302. LCM 340 can receive information and generate a bitmap indicative of a user interface for user account 224 associated with user 300 that includes information such as the number of times user 300 has caused products to be sent to an incineration facility.

Referring now to operation 944, it illustrates displaying an intensity-of-use score that is based at least in part on an output from an intensity-of-use indicator associated with at least the first portion of the physical product. For example, user interface 310 of device 302 can be configured to display a score such as a number or an indication, e.g., “good,” “average,” “poor,” etc. that is based on the output from intensity-of-use indicator 322.

In an exemplary embodiment, the intensity-of-use score can be obtained by LCM 118 from reward/penalty table 248. For example, reward/penalty table 248 can store information such as various outputs from an intensity-of-use indicator in relation to different scores. LCM 118 can be configured to search reward/penalty table 248 using a device-readable indicator and the output in a search query and obtain the score. LCM 118 can then send a message to device 302 that includes the score to device 302, e.g., LCM 118 can compose a message and route the message to network adaptor 122, which can send one or more packets of information to an address of device 302, e.g., an IP address, a domain name, a MAC address, etc., of device 302. Network adaptor 352 can receive the message; extract the score; and route the score to client LCM 340, which can process the score and cause user interface 310 to render an image indicative of the score.

In a specific example, suppose product 102 is a gas powered lawn mower. In this example, suppose user 300 wants to know if he or she is using the lawn mower efficiently. User 300 can use device 302 can receive a selection of the lawn mower and an indication that user 300 would like to know his score for using the lawn mower. In this example, suppose intensity-of-use indicator 322 tracks operation time for the lawn mower and displays a readout. In this example, user 300 can type the readout into device 302 and send a message to the IP address of ecological service provider 122. In this example, the message could include information such as a device-readable indicator for the lawn mower, the readout, an indication that user 300 desires an intensity-of-use score. LCM 118 can receive the message from network adaptor 122 and process it. LCM 118 can use the readout and the device-readable indicator to search reward/penalty table 248. In this example, reward/penalty table 248 may include a column that has operational time per week values and corresponding scores. In this example, LCM 118 can find a score, e.g., the score could be “poor” because the lawn mower is not used often, and send the score back to device 302 where it can be displayed by user interface 310. In this specific example, perhaps user 300 will begin lending his lawn mower to other users so that he can raise his score.

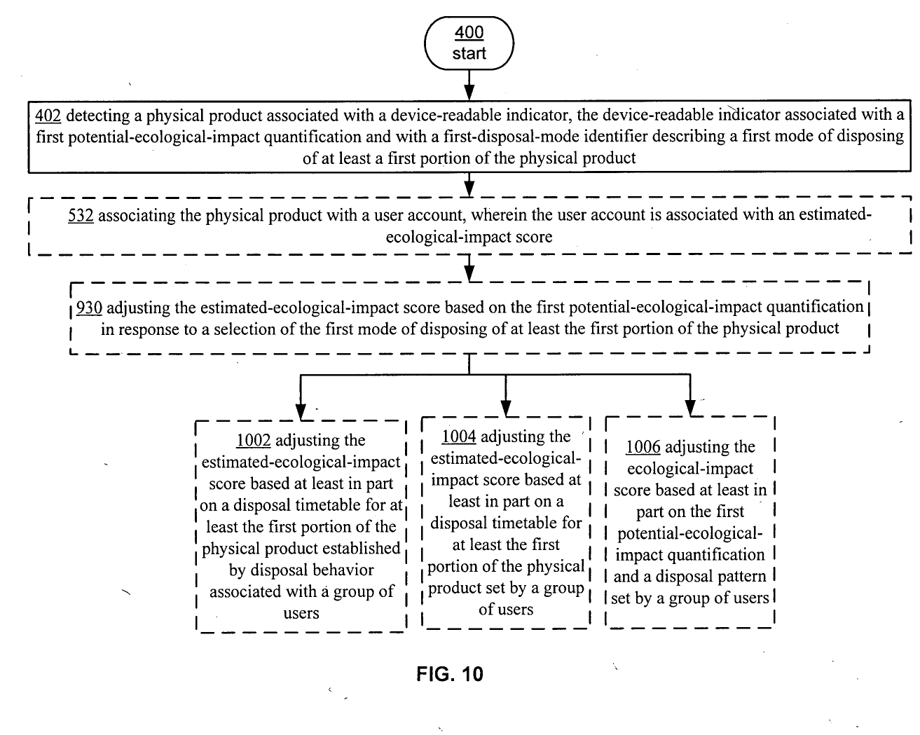

Turning now to FIG. 10, it illustrates an alternative embodiment of the operational procedure depicted by FIG. 9B and operational procedure for practicing aspects of the present disclosure including operations 1002-1006.

Referring to operation 1002, it shows adjusting the ecological-impact score based at least in part on a disposal timetable for at least the first portion of the physical product established by disposal behavior associated with a group of users. In an exemplary embodiment, and referring to FIG. 2, ecological-impact score 230 can be adjusted by LCM 118. In this example, LCM 118 can be configured to adjust ecological-impact score 230 based on at least the first potential-ecological-impact quantification and a disposal timetable established by a group of users stored in quantification adjustment table 242 and/or in group 250. In this example, the disposal timetable can be associated with a threshold amount of time, e.g., a week, a month, etc., set in accordance with information that describes how a group of users, e.g., friends of user 300 stored in friend list 232 or members of group 250, have previously disposed of similar products. Thus, this value can change over time.

In an example embodiment, ecological-impact score 230 can be increased by an additional amount in the instance that user 300 disposes of product 102 before the time threshold stored in the disposal timetable and ecological-impact score 230 can be reduced by an amount in the instance that user 300 disposes of product 102 after the time threshold. For example, if the threshold is 1 year, a reducing adjustment-quantification can be used to modify the first potential-ecological-impact quantification in the instance that user 300 disposed of product 102 after the length of time stored in quantification adjustment table 242 (that is, the first potential-ecological-impact quantification can be reduced) or a increasing adjustment-quantification can be used in the instance that user 300 disposes of product 102 before the length of time expires in quantification adjustment table 242 (that is, the first potential-ecological-impact quantification can be increased.)

In an exemplary embodiment, LCM 118 can maintain a group table for the group that user 300 belongs to, e.g., group profile store 240. When LCM 118 updates product list 226 to indicate that a product has been disposed, LCM 118 can obtain a timestamp indicating when the product was associated with user account 224 and use the timestamp and the current time to calculate how long product 102 has been associated with user account 224. LCM 118 can lookup user account 224 to determine if user account 224 is a member of a group in group profile store 240 and add use the length of time that product 102 was associated with user account 224 to update a disposal timetable for this type of product.

In a specific example, suppose user 300 is a member of a group such as group 250 and disposes of a mobile phone. LCM 118 can receive a message indicating that, for example, a landfill disposal mode was selected and obtain a landfill potential-ecological-impact quantification for the mobile phone, e.g., 13 points. In this example, LCM 118 can use device-readable indicator 314 and an indicator for group profile store 240 to search quantification-adjustment table 242 to determine that the mobile phone is mapped to a threshold value of 1 year (which could be the average length of time, mean length of time, etc., members of group 250 have kept mobile phones). LCM 118 could check product list 226 to determine how long the mobile phone has been associated with user account 224 and determine that user 300 has had the mobile phone for 4 years. In this example, LCM 118 can compare the length of time user 300 has had the mobile phone to the threshold and determine that user 300 has use mobile phone for longer than the threshold. LCM 118 can identify a constant, e.g., 6: 2 points for each year over the threshold, and reduce the value by the constant, e.g., 13−6=7. LCM 118 can then add 7 impact points to ecological-impact score 230. In this example, user 300 was rewarded for using his or her mobile phone efficiently by having his or her ecological-impact score 230 reduced.

Continuing with the description of FIG. 10, operation 1004 shows adjusting the ecological-impact score based at least in part on a disposal timetable for at least the first portion of the physical product set by a group of users. In an exemplary embodiment, and referring to FIG. 2, ecological-impact score 230 can be adjusted by LCM 118. In this example, LCM 118 can adjust ecological-impact score 230 based on a disposal timetable set by a group of users and stored in quantification adjustment table 242. In this example, a threshold can be established and associated with values, which can be used to modify ecological-impact score 230 based on how the user's behavior compares to the threshold.

In this example, the time threshold in the disposal timetable can be set by members of a “green” organization that comprises a group of users such members of group 250. For example, members of group 250 can decide what a reasonable time is for owning a product before disposing it and set a standard.

In an exemplary embodiment social networking module 116 can be used to create and control group 250. For example, social networking module 116 can be configured to generate one or more web-pages operable to allow a group, such as a group 250 to be created and store information indicative of group 250 within group profile store 240. Users such as user 300 can download a copy of a web-page generated by social networking module 116 that can allow user 300 to affiliate him or herself with group 250. In this example, a controlling member of the group, or anyone in the group, can set the time threshold for group 250 by inputting the threshold into a web-page generated by social networking module 116. The web-page can be saved and stored in group profile 240. In another example embodiment, the timetable can be set by a product manufacturer 104.

In a specific example, suppose user 300 disposes of a car and is a member of a “Green-Vehicle User Group,” which includes members that pride themselves on using cars in an environmentally responsible way. In this example embodiment, user 300 decides to dispose of his car after 11 years of use and selects a recycle disposal mode. In this example, LCM 118 can receive a signal indicative of the selection and check user account 224 and determine that user 300 is a member of the group, and load a quantification adjustment table for the group such as quantification adjustment table 242. The quantification adjustment table 242 can have a threshold set to 10 years for this type of vehicle and −1 points for every year after 10 that the car is kept. In this example, the threshold could have been extracted from the Green-Vehicle User group's profile stored in group profile store 240. In this example, LCM 118 can add −1 impact points to ecological-impact score 230.

Turning now to operation 1006, it shows adjusting the ecological-impact score based at least in part on the first potential-ecological-impact quantification and a disposal pattern set by a group of users. In an exemplary embodiment, and referring to FIG. 2, ecological-impact score 230 can be adjusted by LCM 118. In this example, LCM 118 can be configured to adjust ecological-impact score 230 based on at least the first potential-ecological-impact quantification and a disposal pattern set by a group of users.

In this example, the time threshold in the disposal timetable can be set by members of a “green” organization that comprises a group of users such members of group 250. For example, members of group 250 can decide what are the acceptable means of disposing of products and set a standard that rewards members of group 250 for disposing of products in a way favored by group 250 and/or punishing members of group 250 for disposing of products in a way that is disfavored by members of group 250.

In an exemplary embodiment social networking module 116 can be used to create and control group 250. For example, social networking module 116 can be configured to generate one or more web-pages operable to allow a group, such as a group 250 to be created and store information indicative of group 250 within group profile store 240. Users such as user 300 can download a copy of a web-page generated by social networking module 116 that can allow user 300 to affiliate him or herself with group 250. In this example, a controlling member of the group, or anyone in the group, can set which disposal modes are favored/disfavored for group 250 by inputting the information into a web-page generated by social networking module 116. The web-page can be saved and stored in group profile 240. In another example embodiment, the favored/disfavored disposal modes can be set by a product manufacturer 104.

In a specific example, suppose user 300 decides to dispose of his laptop by sending it to a landfill and selects a landfill disposal mode. In this example, LCM 118 can receive a message that includes information indicative of the selection and obtain a potential-ecological-impact quantification for disposing of the laptop via a landfill, which could be 20 impact points. In this example, LCM 118 can use information indicative of user account 224 to determine that user 300 is a member of group 250, and load quantification adjustment table 242 for the group. The quantification adjustment table 242 can indicate that this disposal method is disfavored and have a value of 15 impact points associated with it. In this example, LCM 118 can add 15 to 20 impact points and add 35 impact points to ecological-impact score 230. In this example, user 300 is punished for disposing of his laptop in an environmentally unfriendly way as determined by members of group 250.

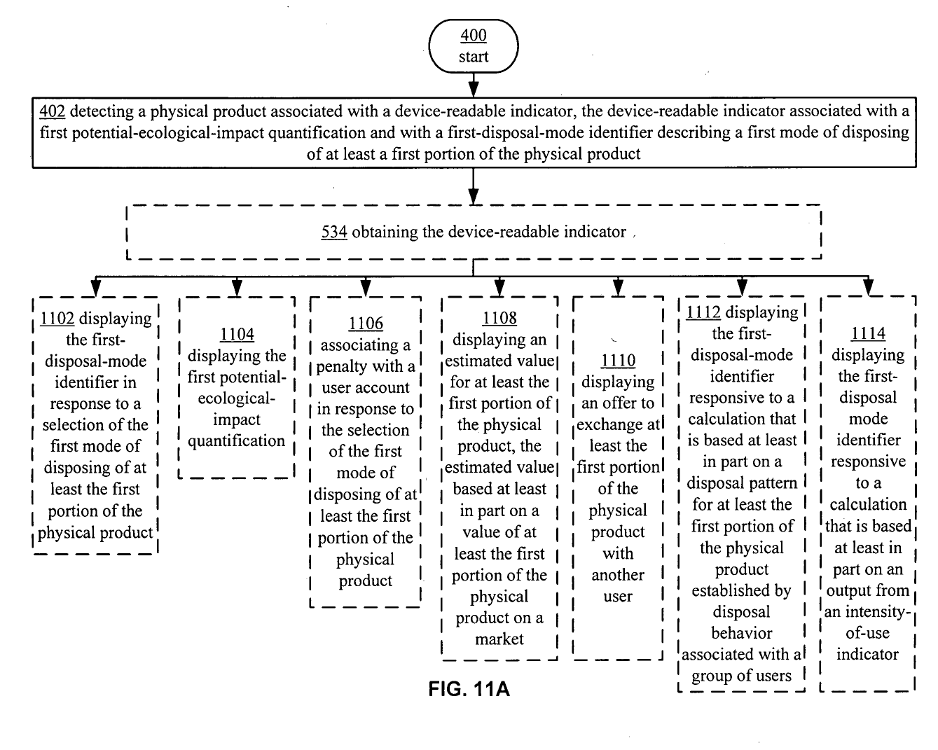

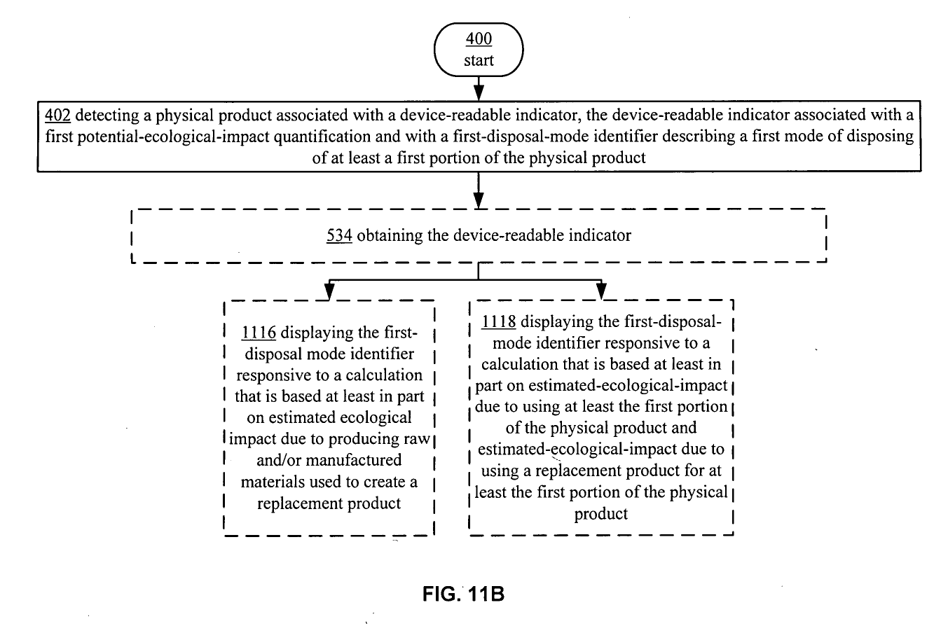

Turning now to FIG. 11, the operational procedures associated with FIG. 11 have been split up between FIG. 11A and FIG. 11B for easy of illustration. Thus, in exemplary embodiments of the present disclosure operations 1102-1114 illustrated in FIG. 11A can, be executed in conjunction with operations 1116 and 1118 illustrated in FIG. 11B and vice versa.

The operational procedure of FIG. 11A includes operation 1102, which shows displaying the first-disposal-mode identifier in response to a selection of the first mode of disposing of at least the first portion of the physical product. For example, and referring to FIG. 3, device 302, which can be a mobile device, can include user interface 310, e.g., a touch interface. In this example, user interface 310 can be configured to render a bitmap indicative of the first disposal-mode identifier in response to receiving a selection, e.g., user input, indicative of a request to dispose of product 102 according to the first disposal mode.

In a specific example, LCM 340 can be configured to generate a bitmap indicative of a screen that includes an option to select at least a first mode of disposing of at least a part of product 102. For example, LCM 340 can generate an image indicative of a user a screen that includes an icon that includes text such as “display disposal mode options.” LCM 340 can receive user input indicative of a selection of the icon and send a request to client database 342 and/or database 114 that includes, for example, device-readable indicator 314. Client database 342 and/or 114 can receive device-readable indicator 314 and use it as a search parameter to search disposal mode identifier table 214 for product 102. A first-disposal-mode identifier can be found and sent to LCM 340, which can use the received first-disposal-mode identifier to generate an image that describes the first mode of disposing of product 102. In a specific example, the image may include text such as “Product 102 can be recycled by placing product 102 in the blue recycling bin.”

Continuing with the description of FIG. 11, operation 1104 shows displaying the first potential-ecological-impact quantification. For example, and referring to FIG. 3, device 302 can be configured to obtain device-readable indicator 314. LCM 340 can receive a first potential-ecological-impact quantification and cause user interface 310 to render a bitmap that depicts the first potential-ecological-impact quantification.

In a specific example embodiment, the first potential-ecological-impact quantification can be displayed in response to receiving user input via user interface 310. For example, LCM 340 can be configured to pass device-readable indicator 314 to client database 342, which can use device-readable indicator 314 to search disposal phase quantification table 220 and find the first potential-ecological-impact quantification. First potential-ecological-impact quantification can be returned to LCM 340 in response to a search and LCM 340 can cause it to be displayed by generating a bitmap, i.e., an image, and sending the bitmap to user interface 310 for rendering.

In another specific example, suppose user 300 wishes to see the potential-ecological-impact quantification caused by disposing of product 102 according to a first disposal mode prior to purchasing product 102 from product retailer 106. In this example, user 300 could press a button displayed on user interface 310 that is associated with text such as “Obtain information about product,” and camera 304 could take a picture of product 102. In this example, camera 304 could send the picture to LCM 340, which can search a local copy of image table 246 for a match for the picture to obtain device-readable indicator 314. In this specific example, a match could be found and LCM 340 could obtain device-readable indicator 314. LCM 340 can use device-readable indicator 314 to search disposal phase quantification table 220 and find the first potential-ecological-impact quantification. LCM 340 can receive the first potential-ecological-impact quantification and cause user interface 310, e.g., a display, to render an image that includes at least first potential-ecological-impact quantification.

Turning to operation 1106, it shows associating a penalty with a user account in response to the selection of the first mode of disposing of at least the first portion of the physical product. For example, and referring to FIG. 3, LCM 340 can be configured to penalize user 300 for disposing of product 102 according to the first disposal mode. For example, reward/penalty table 248 can include a table for product 102 that includes a column for penalty information for disposal modes.

According to a specific exemplary embodiment, LCM 118 can receive a message including information identifying user account 224, device-readable indicator 314, and a disposal-mode identifier from device 302. In this example, LCM 118 can open a table for product 102 in reward/penalty table 248. LCM 118 can then search the table using the selected disposal-mode identifier to find a penalty to associate with user account 224. In an exemplary embodiment, a penalty can be effected by, for example, sending a signal to a third party that can adjust a service for a user, e.g., a cable company can increase the user's price he or she pays for Internet access to penalize user 300, cause a graphic to be displayed on a social networking webpage that indicates that user 300 has acted in an environmentally unfriendly way, etc.

In yet another example embodiment, reward/penalty table 248 can include a column for the number of times a disposal mode has been selected and an associated column that indicates a penalty for doing so. In a specific example, a user may be allowed to dispose of products via a disposal mode a number of times, e.g., 10, 20, 100, etc., during a time period, e.g., week, month, year, etc., before he or she is penalized. For example, user 300 may be allowed to landfill products 100 times per month. In this example, LCM 118 can receive a message including information identifying user account 224, device-readable indicator 314, and a disposal-mode identifier associated with a landfilling disposal mode was selected. LCM 118 can access product list 226 to store information that indicates that product 102 was disposed of according to a landfill disposal mode and obtain the number of times user 300 selected this disposal mode in the past month. In this exemplary embodiment, LCM 118 can obtain the number and compare it to a value in reward/penalty table 248. In the instance that user 300 has exceeded the allotted number of disposals according to this mode within the measured time period, LCM 118 can penalize user 300 by associating a penalty with user account 224.

Referring to operation 1108, it shows displaying an estimated value for at least the first portion of the physical product, the estimated value based at least in part on a value of at least the first portion of the physical product on a market. In an exemplary embodiment, user interface 310, e.g., an LCD display of a smart phone, can be configured by LCM 340 to render a bitmap that includes information such as an estimated value of at least a part of product 102.

In a specific example, LCM 340 can be configured to generate a bitmap that includes an icon for receiving “Product value information,” and in response to a selection of the icon, LCM 340 can obtain the value and generate another image that display the value, e.g., a price, that can be based at least in part on the value of product 102 on a market.

In this specific example, LCM 340 can obtain the estimated value of product 102 from product value table 244 in database 114 and/or client database 342. For example, LCM 340 can send device-readable indicator 314 to database 114 and/or client database 342 along with a request for value information. The product value information can be obtained by market module 122, which can be configured to craw market(s) such as Amazon.com®, E-Bay®, etc., and update price information in price table 244. The various price information can be compiled and used to estimate a value for product 102.

Continuing with the description of FIG. 11B, operation 1110 shows displaying an offer to exchange at least the first portion of the physical product with another user. For example, and referring to FIG. 3, device 302, which can be a mobile device, can include user interface 310, e.g., touch interface. In this example, user interface 310 can be configured by a web-browser operable to render web-pages generated by social networking module 116 to render a bitmap indicative of an offer to exchange product 102 with another user, e.g., user 318.

In this specific example, ecological service provider 112 can be associated with an online market, e.g., ecological service provider 112 could maintain such a market or be affiliated with such a market. In this example, the online market can be effectuated by market module 122, which can be configured to allow users to indicate that they would like to obtain certain products and offer something to exchange the product for. In a specific example, user 318 may desire a mobile phone and is willing to trade 10 free workout sessions at his or her gym to obtain the mobile phone. User 318 can use a computer (not shown) to download one or more web-pages from social networking module 116 that include logic that allows user 318 to put his or her offer into a web-page. In response, one or more packets of information can be sent to network adaptor 122 for example. The information can be routed to market module 122, which can be configured to store the offer in product exchange repository 130.

Some time later, when user 300 wants to dispose of product 102, e.g., the mobile phone in this example, user 300 can select an icon indicating that he or she would like to dispose of the mobile phone and a message can be sent to LCM 118 that includes device-readable indicator 314. In response to obtaining device-readable indicator 314, LCM 118 can send a request to market module 122 that includes, for example, device-readable indicator 314 and a request to find offers for product 102. Market module 122 can receive the request and query product exchange repository 130, which can use device-readable indicator 314 to determine whether any other users have set up offers to exchange something for the mobile phone. In this example, product exchange repository 130 can find the offer from user 318 send one or more packets of information via network adaptor 122A to LCM 340. LCM 340 can receive the offer and generate a bitmap that is indicative of the offer and cause user interface 310 to render the image. In this example, user 300 is afforded an opportunity to consider an offer for product 102 prior to or during the process of selecting a disposal mode.

Continuing with the description of the figure, operation 1112 shows displaying the first-disposal-mode identifier responsive to a calculation that is based at least in part on a disposal pattern for at least the first portion of the physical product established by disposal behavior associated with a group of users. For example, and again referring to FIG. 3, device 302, which can be a mobile device, can include user interface 310, e.g., touch interface. In this example, user interface 310 can be configured to render a bitmap that includes first-disposal-mode identifier in response to a calculation that takes into account a disposal pattern for product 102 defined by a group of users.

For example, and referring to FIG. 2, user interface 310 can render an icon such as “display disposal mode options” and user 300 can select the icon. In response, LCM 340 can check client database 342 and/or send a request to LCM 118 to determine if any disposal mode options are available for product 102. For example, LCM 340 can send device-readable indicator 314 ecological service provider 112. In this example, LCM 118 can receive the request and access disposal mode identifier table 214 to obtain disposal-mode-identifiers that are associated with device-readable indicator 314. LCM 118 can also check group profile store 240 to determine if any of the obtained disposal-mode-identifiers are preferred by the group. For example, group profile store 240 could include information that associates user account 224 to group 250, and group 250 can indicate that recycling is the most used method of disposing of this type of product. In this example, LCM 118 can detect that recycling is the preferred method and send one or more packets of information indicative of a disposal-mode-identifier for recycling to device 302. LCM 340 can receive the information and cause user interface 310 to display a bitmap indicative of the recycling disposal mode identifier.

Referring to operation 1114, it shows displaying the first-disposal-mode identifier responsive to a calculation that is based at least in part on an output from an intensity-of-use indicator. For example, and again referring to FIG. 3, device 302, which can be a mobile device, can include user interface 310, e.g., touch interface. In this example, user interface 310 can be configured to render a bitmap that includes a first-disposal-mode identifier in response to a calculation that takes into account an output from intensity-of-use indicator 322.

In an exemplary embodiment, LCM 340 (or LCM 118) can be configured to suggest a certain disposal mode based on the output of the intensity-of-use indicator 322. In this exemplary embodiment, threshold table 234 can be configured to include a column of information such as miles driven, power cycles, number of times washed, hours in operation, etc., associated with the different disposal methods for product 102.

In a specific example, suppose user 300 wants to dispose of his or her car. In this example, user 300 can access his or her device 302 and select an icon that causes user interface 310 to render an image displaying an icon such as “Obtain Disposal Modes for Product.” In response to a selection of the icon, LCM 340 can send a message to LCM 118 that includes the device-readable indicator and the output from intensity-of-use indicator, e.g., the odometer's listed mileage. In this example, LCM 340 could have received intensity-of-use information from, for example, user input. LCM 118 can receive the message and search for the mileage in threshold table. In this example, suppose that miles driven is the metric used for the car to determine whether the car has been used intensely. In this example, suppose miles 1-50,000 may be associated with a resell recommended disposal mode and since the output is within this threshold, LCM 118 can retrieve the disposal-mode-identifier for reselling the car and send it in a message to LCM 340 via network 100 LCM 340 can receive the message and cause a bitmap that includes a recommendation to resell the car to be rendered on user interface 310.

Turning to FIG. 11B it shows additional operations 1116 and 1118 that can be executed in conjunction with one or more of the exemplary operations illustrated by FIG. 11A.

Operation 1116 shows displaying the first-disposal-mode identifier responsive to a calculation that is based at least in part on estimated ecological impact due to producing raw and/or manufactured materials used to create a replacement product. For example, and again referring to FIG. 3, device 302, which can be a mobile device, can include user interface 310, e.g., touch interface. In this example, user interface 310 can be configured to render a bitmap that includes a first-disposal-mode identifier in response to a calculation that takes into account the ecological impact due to creating a replacement product for product 102.

In an exemplary embodiment, the threshold can be set by an organization, a group of users, or derived from disposal behavior. For example, in an embodiment where the threshold is set by disposal behavior, the instances where users opt to replace products with replacement products can be tracked and the average difference between a potential-ecological impact quantification for replacement product and a product can be determined and stored in threshold table 234.

For example, LCM 340 can be configured to cause user interface 310 to render an image displaying an icon such as “Recommend Upgrade for Product 102.” In response to a selection of the icon, LCM 340 can send a message including device-readable indicator 314 to LCM 118 via network 100. LCM 118 can receive the message and use device-readable indicator 314 to obtain a potential-ecological-impact quantification based at least in part on the potential harm caused by producing raw materials and/or manufactured materials needed to create a replacement for product 102. For example, device-readable indicator 314 can be associated with device-readable indicators for related products. The relationship between device-readable indicator 314 and other device-readable indicators can be used to search for a product information repository for a related product. In this example, LCM 118 can obtain a potential-ecological-impact quantification based at least in part on producing raw materials and/or manufactured materials for the replacement product and compare the two potential-ecological-impact quantifications and determine if the difference is greater than a value stored in threshold table 234. In the instance the difference is less than the threshold, LCM 118 can send one or more packets of information to device 302 that include the first disposal-mode-identifier. Device 302 can receive the one or more packets and route the information contained within the packets to LCM 340, which can generate a bitmap and cause user interface 310 to render the bitmap that includes a first-disposal-mode identifier.

Turning to operation 1118, it shows displaying the first-disposal-mode identifier responsive to a calculation that is based at least in part on ecological-impact due to using at least the first portion of the physical product and ecological-impact due to using a replacement product for at least the first portion of the physical product. For example, and again referring to FIG. 3, device 302, which can be a mobile device, can include user interface 310, e.g., touch interface. In this example, user interface 310 can be configured to render a bitmap that includes first-disposal-mode identifier in response to a calculation that takes into account the ecological impact due to using a replacement product for product 102.

In an exemplary embodiment, the calculation can be performed by LCM 118 in response to a request from device 302. For example, LCM 340 can be configured to cause user interface 310 to render an image displaying an icon such as “Obtain Disposal Modes for Product 102.” In response to a selection of the icon, LCM 118 can send a message including device-readable identifier 314 and a request for disposal-mode-identifiers for product 102 to LCM 118. In this example, LCM 118 can receive the request; obtain disposal-mode-identifiers from disposal mode identifier table 214; and determine whether or not to display such one or more of the disposal-mode-identifiers based on a calculation that takes into account the harm potentially caused by using product 102 and the harm potentially caused by using a replacement product. For example, LCM 118 can send a request to database 114 that includes a device-readable indicator and a request for potential-ecological-impact quantification associated with using product 102 and a request for a potential-ecological-impact quantification associated with using a replacement product. In this example, product information repository 202 can store relationship information for products and it can link a replacement product to product 102. For example, the replacement product can be “next years model” of product 102.

LCM 118 can receive potential-ecological-impact quantifications for using both product 102 and a replacement product and compare them to each other. In an embodiment, if the potential-ecological-impact quantification for using the replacement product is less than the potential-ecological-impact quantification for using product 102, LCM 118 can be configured to select a disposal-mode-identifier for the first disposal mode. LCM 118 can send one or more packets of information to device 302 indicative of the first-disposal mode-identifier and LCM 340 can be configured to cause the first-disposal mode-identifier to be displayed on user interface 310.

In a specific example, product 102 may be a washing machine. In this example, LCM 118 can be configured to periodically compare potential-ecological-impact quantifications associated with using products stored in product list 226, such as the washing machine, to potential-ecological-impact quantifications for replacement products.

In this specific example embodiment, LCM 118 can determine that one or more products, such as the washing machine, should be disposed of based on a calculation that takes into account a potential-ecological-impact quantification for using the washing machine and a potential-ecological-impact quantification for using a replacement washing machine, e.g., the washing machine currently in use is very inefficient compared to the newer model, and send a signal indicative of the first-disposal-mode-identifier, e.g., a recycle disposal mode identifier, to product 102 and/or device 302. For example, the washing machine could receive a signal and display the first-disposal-mode-identifier on a LCD screen and/or device 302 could receive a text, email, etc., that causes user interface 310 to display the first-disposal-mode-identifier.

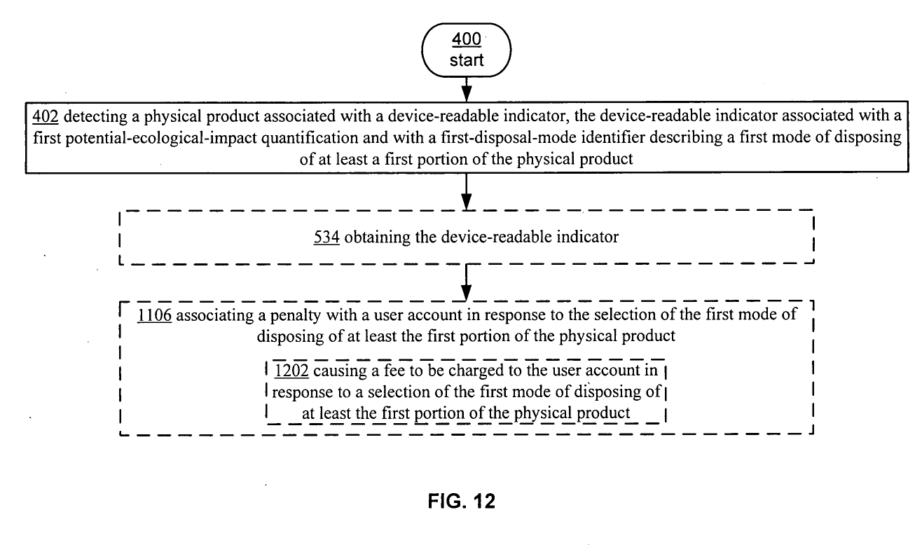

Referring now to FIG. 12, it illustrates an alternative embodiment of the operational procedure illustrated by FIG. 11A including the additional operation 1202.

Operation 1202 illustrates that in an exemplary embodiment the operational procedure can include the operation causing a fee to be charged to the user account in response to a selection of the first mode of disposing of at least the first portion of the physical product. For example, and referring to FIG. 2, LCM 118 can be configured to charge user 300 a fee in response to a selection of a first-disposal-mode identifier. For example, LCM 118 can receive a message including information that indicates that a user associated with user account 224 selected the first mode of disposing of at least the first part of product 102 and LCM 118 can send a message to a billing department, e.g., a billing department associated with ecological service provider 112, that includes a request to charge user account 224 a fee.

In an exemplary embodiment, the amount charged can be obtained from reward/penalty table 248. For example, reward/penalty table 248 can include a column that maps different disposal modes to different fees. In this example, LCM 118 can be configured to check reward/penalty table 248 in response to receiving a message that includes information that indicates that user 300 associated with user account 224 selected the first mode of disposing of at least the first part of product 102. LCM 118 can use, for example, device-readable identifier 314 and a disposal-mode-identifier to search reward/penalty table 248 to locate a fee to charge. In this example, LCM 118 can then cause a fee to be charged to user account 224 by sending a message to a billing department that can effect the charge.

In the same, or an alternative embodiment, user account 224 can be associated with a maximum number of times user 300 can dispose of products according to a disposal mode within a given time period, e.g., one week, month, etc. In this example, reward/penalty table 248 can include a column that maps different disposal modes to fee-thresholds, i.e., the number of times the disposal mode was selected during the measured time period, and different fees to be charged if the number of times the disposal mode was selected during the measured time period is larger than the number in the column. In this example, LCM 118 can be configured to check reward/penalty table 248 in response to receiving a message that includes information that indicates that user 300 with user account 224 selected the first mode of disposing of at least the first part of product 102. LCM 118 can use device-readable identifier 314 and a disposal-mode-identifier to access product list 226 and determine the number of times that user 300 selected the disposal mode associated with the disposal-mode-identifier during a given time period, e.g., one day, one month, one year, etc. LCM 118 can then search reward/penalty table 248 to locate a fee to charge and compare the number of times obtained from product list 226 to the fee-threshold. In the instance that the number of times the disposal mode was selected is greater than the fee-threshold, LCM 118 can then cause a fee to be charged to user account 224 by sending a message to a billing department that can effect the charge.

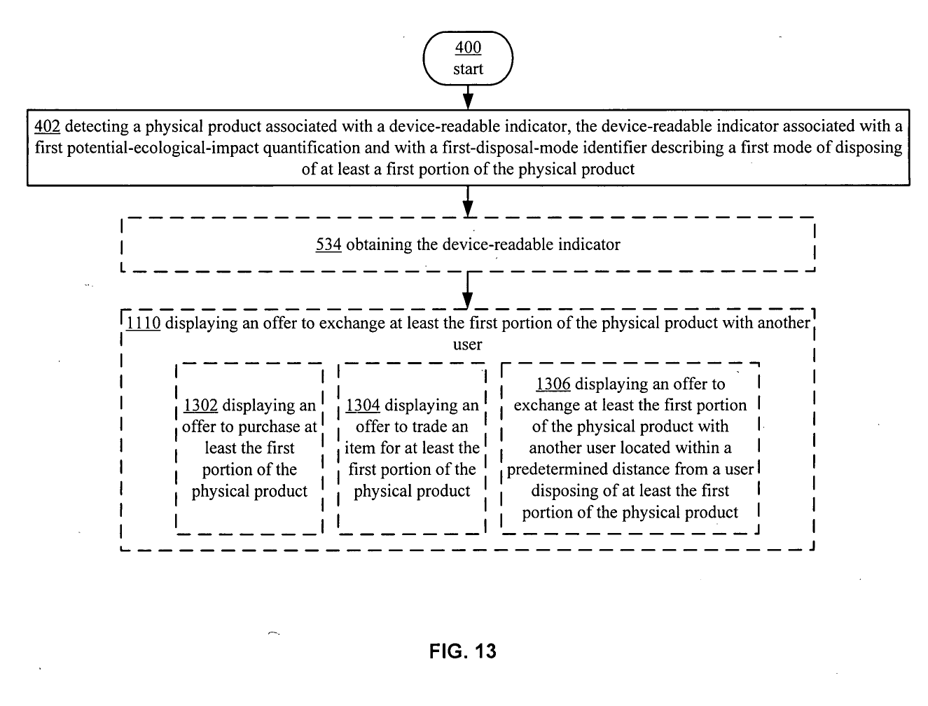

Referring to FIG. 13, it illustrates an alternative embodiment of the operational procedure illustrated by FIG. 11A including the additional operations 1302-1306.

Referring to operation 1302, it illustrates that in an exemplary embodiment, the operational procedure can include displaying an offer to purchase at least the first portion of the physical product. For example, and referring to FIG. 3, in an exemplary embodiment LCM 340 can generate an image that includes an offer to purchase product 102 and cause the image to be rendered on user interface 310.

In an example embodiment, ecological service provider 112 can be associated with an online market, e.g., ecological service provider 112, could maintain such a market or be affiliated with such a market. In this example, the market can be associated with market module 122, which can be configured to generate one or more web-pages that can be downloaded by user computer devices and used to allow users to indicate that they would like to obtain certain products and offer something to exchange for product 102. In this specific example, the offer could be to purchase a phone for a price, e.g., $200. In a specific example, a user such as user 318 may desire a mobile phone and is willing to buy the mobile phone for $200. User 318 can input the offer into a web-page and the offer can be sent to market module 122 via network 100. The offer can then be stored in exchange repository 130.

Sometime after the offer is stored in exchange repository 130, user 300 could indicate to device 302 that he or she would like to dispose of a mobile phone similar to the mobile phone desired by user 318 by selecting a button rendered on user interface 310. In this example, device 302 can obtain device-readable indicator 314 and send it to LCM 118 via network 100. In this example, LCM 118 send a request to exchange repository 130 for any offers for the mobile phone or a similar mobile phone. In this specific example, exchange repository 130 can find the offer associated with user 318 and return it to LCM 118, which can send one or more packets of information indicative of the offer to device 302. In this example, device 302 can receive the packets and route the information to LCM 340, which can generate a bitmap indicative of the offer and cause user interface 310 to render the bitmap.

Continuing with the description of FIG. 13, operation 1304 shows displaying an offer to trade an item for at least the first portion of the physical product. For example, and referring to FIG. 3, user interface 310 can render an image that includes an offer to trade an item for product 102. In an exemplary embodiment, the image could be generated in memory by a web-browser or LCM 340 and then rendered to user interface 310.

In an example embodiment, ecological service provider 112 can be associated with an online market, e.g., ecological service provider 112, could maintain such a market or be affiliated with such a market. In this example, the market can be associated with market module 122, which can be configured to generate one or more web-pages that can be downloaded by user computer devices and used to allow users to indicate that they would like to obtain certain products and offer something to exchange for product 102. In this specific example, the offer could be to trade a snow blower for a digital camera. In this specific example, user 318 can input the offer into a web-page and the offer can be sent to market module 122 via network 100. The offer can then be stored in exchange repository 130.

Sometime after the offer is stored in exchange repository 130, user 300 could indicate to device 302 that he or she would like to dispose of, for example, the same version of the digital camera that user 318 desires by selecting a button rendered on user interface 310. For example, device 302 may open a web-browser and user 300 could navigate to www.socialnetworkingmodule.com or the like, and social networking module 116 can receive the request and send a web-page back to device 302. In this example, user 300 could submit input that causes a web-page to download that allows user to indicate that he or she would like to dispose of his or her digital camera. In this specific example, device 302 can obtain device-readable indicator for the camera and information identifying user account 224 send a message containing this information to social networking module 116 via network 100. In this example, the message can be routed to LCM 118, which can determine that the message includes a request to dispose of the digital camera. LCM 118 can receive the message and send a message to exchange repository 130 for any offers for the digital camera. In this specific example, exchange repository 130 can find the offer associated with user 318 and return it to LCM 118, which can send one or more packets of information indicative of the offer to social networking module 116. In this example, social networking module 116 can generate a web-page including the offer and send one or more packets indicative of the web-page to device 302. A web-browser can receive the web-page and cause user interface 310 to render the web-page.

Referring now to operation 1306, it shows displaying an offer to exchange at least the first portion of the physical product with another user located within a predetermined distance from a user disposing of at least the first portion of the physical product. For example, user interface 310 can render an image that includes an offer to exchange at least a part of product 102 with a user, e.g., user 318, that is within a predetermined distance from user 300.

In this example, user 300 can indicate to device 302 that he or she would like to dispose of product 102. For example, device 302 may have received a signal indicative of a request to dispose of product 102 from user 300. In response to the signal, device 302 can send a message to ecological service provider 112 that can include information identifying user account 224, device-readable indicator 314, and location information such as the output from device location determination module 308, which could be a GPS radio or the link. LCM 118 can receive the message and send a request to market module 122 for any offers for product 102. Market module 122 can search exchange repository 130 for offers and send information indicative of offer(s) back to LCM 118. In this example, LCM 118 can send location update requests to devices associated with the offers and receive location information. LCM 118 can compare the location information for the device(s) associated with the offer(s) to the location information from device 302 and determine if any of the devices are within a predetermined distance. In the instance that the devices are within a predetermined distance, e.g., 1 mile, 5 miles, 10, miles, etc., LCM 118 can send the offers from the associated users to device 302. Device 302 can receive the offer(s) cause user interface 310 to render an image indicative of the offer(s).

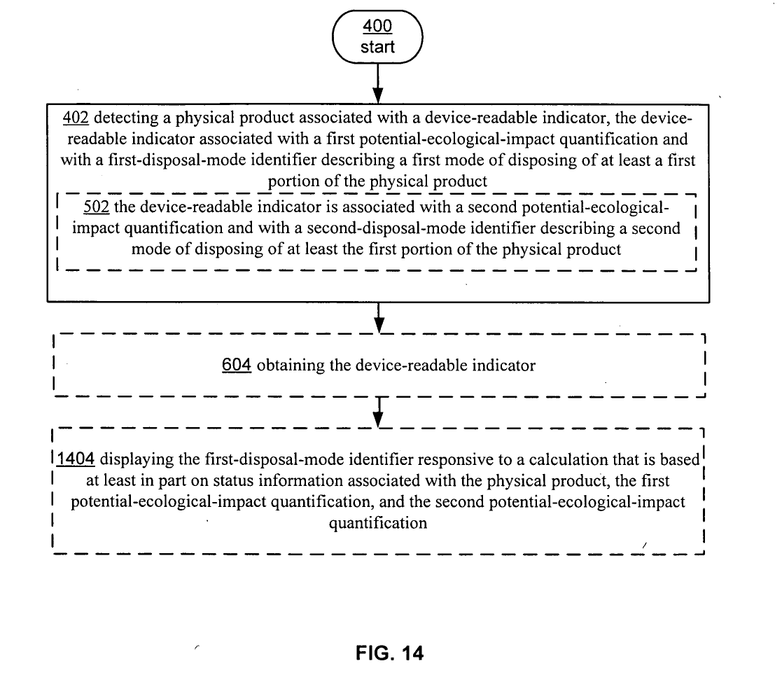

Referring to FIG. 14, it illustrates an alternative embodiment of the operational procedure illustrated by FIG. 11B including the additional operation 1404.

For example, operation 1402 illustrates displaying the first-disposal-mode identifier responsive to a calculation that is based at least in part on status information associated with the physical product, the first potential-ecological-impact quantification, and the second potential-ecological-impact quantification. For example, and again referring to FIG. 3, device 302, can include user interface 310, e.g., touch interface. In this example, user interface 310 can be configured to render a bitmap that includes first-disposal-mode identifier in response to a calculation that takes into account first and second potential-ecological-impact quantifications for product 102 and an output from status determination module 360. In an exemplary embodiment, the output from status determination module 360 can be used to indirectly determine how “used up” and/or “consumed” product 102 is. In a specific example, product 102 may be a computer system and status determination module 360 could be a module, e.g., a part of an operating system, that monitors the health of the computer system by tracking information such as average power consumed, operational time, etc.

In an exemplary embodiment, status determination module 360 can send its output to device 302 in response to a request. For example, device 302 could request such information in response use input, e.g., user interface 310 can receive a selection of an icon such as “Recommend Disposal Modes for Product 102.” Device 302 can obtain device-readable identifier 314 for product 102 and the output from status determination module 360, e.g., the length of time product has been operational over its life. Device 302 can send a message to ecological service provider 112 that includes device-readable indicator 314, information that identifies user account 224, the output from status determination module 360. Ecological service provider 112 can receive the message and route it to LCM 118.

In this exemplary embodiment, LCM 118 can be configured to use device-readable indicator 314 to search disposal mode identifier table 214 to locate one or more disposal mode options for product 102 and locate one or more potential-ecological-impact quantifications associated with the obtained disposal-mode-identifiers. For example, the disposal mode options could include a resell disposal-mode-identifier, a resell disposal-mode-identifier, etc.

LCM 118 can also use output from status determination module 360 and device-readable identifier 314 to search quantification adjustment table 242 to determine whether any of the potential-ecological-impact quantifications for product 102 should be adjusted based on the output from status determination module 360. In this example, quantification adjustment table 242 can include adjustment-quantifications for disposal modes that are sensitive to the status of product 102. For example, disposal modes such as resell may be less desirable for old products or products that are worn out.

LCM 118 can obtain one or more adjustment-quantifications and use it or them to affect one or more potential-ecological-impact quantification for one or more disposal modes. LCM 118 can then compare the adjusted-potential-ecological-impact quantifications and recommend the disposal mode associated with the lowest adjusted-potential-ecological-impact quantification. In this example, LCM 118 can send a signal indicative of selected disposal-mode-identifier to device 302, which can render the disposal-mode-identifier on user interface 310.

In a specific example, suppose product is associated with two disposal-mode-identifiers: one for reselling and one for incinerating. Also suppose that the output of status determination module 360 indicates that product 102 is old, e.g., has been in operation for thousands of hours, the potential-ecological-impact quantification for reselling it is zero, and the potential-ecological-impact quantification for incinerating it is 4. In this example, suppose quantification adjustment table 242 includes an adjustment-quantification of 5 for product 102 based on the output of status determination module 360. In this example, LCM 118 can use device-readable identifier 314 to obtain disposal-mode-identifiers for reselling and incinerating and find the associated potential-ecological-impact quantifications from disposal phase quantification table 220.

In response to obtaining information from disposal phase quantification table 220, LCM 118 can then search quantification adjustment table 242 and determine that an adjustment-quantification for the resell mode is 5 based on the output associated with status determination module 360. LCM 118 can use the adjustment-quantification to modify the potential-ecological-impact quantification for reselling product 102, e.g., the quantifications could be added to arrive a value of 5 (0+5=5), and the adjusted potential-ecological-impact quantification for reselling compared to the potential-ecological-impact quantification associated with incinerating product 102, e.g., 4 in this example. LCM 118 can determine that incinerating product 102 is lower and select the incineration disposal-mode-identifier. LCM 118 can then send one or more packets indicative of the disposal-mode-identifier associated with incineration to device 302, which can cause user interface 310 to render a recommendation including an incineration disposal mode.

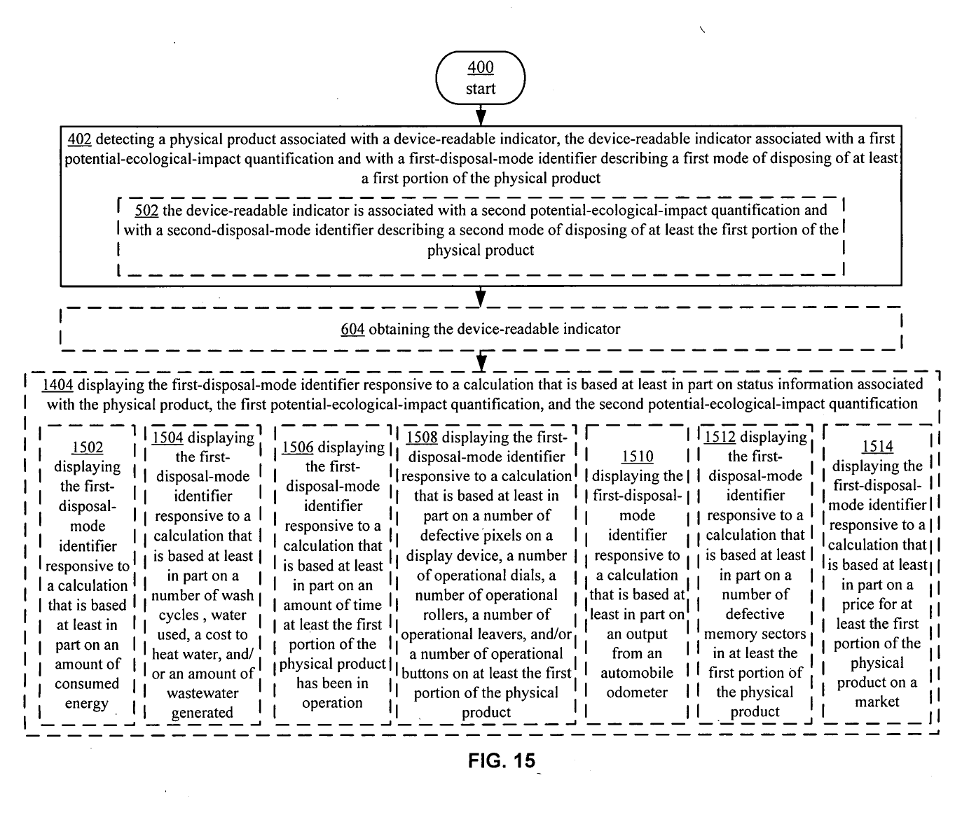

Turning to FIG. 15, it illustrates an alternative embodiment of the operational procedure illustrated by FIG. 14 including the additional operations 1502-1514.

Operation 1502 shows displaying the first-disposal-mode identifier responsive to a calculation that is based at least in part on an amount of consumed energy. For example, in an embodiment the output from status determination module 360 can indicate the amount of energy that product 102 has consumed over a time period such as, for example, its life, or since it has been controlled, e.g., owned, by user 300, etc. For example, product 102 can be a mobile phone. In this example, the mobile phone can include status determination module 360, which can could include a sensor that tracks the amount of energy that the mobile phone uses over time.

Quantification adjustment table 242 in this example can include information associated with a device-readable identifier for the mobile phone that maps ranges of power consumed to adjustment-quantifications, which can be used to influence a calculation to determine whether to display the first potential-ecological-impact quantification or the second potential-ecological-impact quantification.

For example, suppose the mobile phone has at least two disposal modes: resell and recycle and that the mobile phone has consumed approximately 3,100 kilowatts of power. In this example, the amount of power consumed could be mapped to an adjustment-quantification that reflects how old the mobile phone is based on the fact that it has consumed 3,100 kilowatts of power. In a specific example, suppose 3,100 kilowatts of consumed power places the mobile phone at about two to three years old. In this example, the adjustment-quantification can be used to influence the selection of a resell disposal mode by making the resell less likely to be selected by LCM 118 as a recommended disposal mode.

In a specific example, suppose a potential-ecological-impact quantification associated with reselling mobile phone is 0, a potential-ecological-impact quantification associated with recycling the mobile phone is 2, and the adjustment-quantification is 4. In this example, LCM 118 could add the adjustment-quantification to the potential-ecological-impact quantification associated with reselling mobile phone; compare the two; and select the disposal mode that has the lower ecological-impact quantification, e.g., the recycling disposal mode.

Turning to operation 1504, it shows displaying the first-disposal-mode identifier responsive to a calculation that is based at least in part on a number of wash cycles, water used, a cost to heat water, and/or an amount of wastewater generated. For example, in an embodiment, user interface 310 can render an image that includes the first-disposal-mode identifier. For example, the first-disposal-mode-identifier could include instructions for disposing of product 102 according, for example a recycling mode, e.g., the instructions could include text, audio, graphics, etc., that describe a way to recycle product 102 such as text that states “to recycle product 102 you may call this number.”

Quantification adjustment table 242 in this example can include information associated with a device-readable identifier for product 102 that maps the number of times product 102, which could be a washing machine, dishwasher, etc., has initiated a wash cycle, how much water product 102 has consumed, a cost to heat the water consumed by product 102, and/or an amount of wastewater that was generated by product 102 to adjustment-quantifications, which can be used to influence a calculation to determine whether to display the first potential-ecological-impact quantification or the second potential-ecological-impact quantification.

In another example, product 102 can be an article of clothing that can track the number of times that it has been washed. For example, product 102 could include status determination module 360, which in a specific example, could be a sensor that detects the presence of detergent in water, a sensor that detects the degree of wetness, and/or a acceleramoter sensor calibrated to detect vibrations from a spin cycle and increment a counter.

Quantification adjustment table 242 in this specific example can include information associated with a device-readable identifier for product 102 that maps the number of times the article of clothing, e.g., a shirt, has been washed a to adjustment-quantifications, which can be used to influence a calculation to determine whether to display the first potential-ecological-impact quantification or the second potential-ecological-impact quantification.

Turning to operation 1506, it shows displaying the first-disposal-mode identifier responsive to a calculation that is based at least in part on an amount of time at least the first portion of the physical product has been in operation. For example, user interface 310 can render an image that includes the first-disposal-mode identifier. For example, product 102 can include status determination module 360, which can track the amount of time that product 102 has been in operation and this information can be used to infer the status of product 102.

Similar to the preceding operations, quantification adjustment table 242 can include information associated with a device-readable identifier for product 102 that maps operational time to adjustment-quantifications, which can be used to influence a calculation to determine whether to display the first potential-ecological-impact quantification or the second potential-ecological-impact quantification.

In a specific example, suppose product is a blender with status determination module 360, e.g., timer configured to monitor the length of time the blender has blended. In this example, the length of time that the blender has been in operation can be used to infer the age of the blender and/or its effectiveness. After user 300 determines he or she wants to dispose of the blender, he or she can use device 302 to obtain the length of time product 102 was has been in operation via, for example, a Bluetooth® connection established between device 302 and the blender. In this example, LCM 340 could send a message to LCM 118 that includes the output from status determination module 360 a device-readable identifier for the blender, etc. LCM 118 can receive the message and use the device-readable identifier to look up disposal-mode-identifiers for the blender and associated potential-ecological-impact quantifications for the disposal modes. LCM 118 could also search quantification adjustment table 242 for adjustment quantifications to use to adjust potential-ecological-impact quantifications.

In this example, LCM 118 could locate an adjustment-quantification and add the adjustment-quantification to the potential-ecological-impact quantification associated with reselling the blender and compare the adjusted-potential-ecological-impact quantification for reselling the blender to, for example, a potential-ecological-impact quantification for recycling the blender. In this example, LCM 118 can determine that the potential-ecological-impact quantification for recycling the blender is lower than the adjusted-potential-ecological-impact quantification for reselling the blender; and select the disposal mode that has the lower ecological-impact quantification, e.g., the recycling disposal mode; and send a message including the disposal-mode-identifier for recycling the blender to device 302. Device 302 can receive the message and cause user interface 310 to display the disposal-mode-identifier for recycling the blender.

Operation 1508 shows displaying the first-disposal-mode identifier responsive to a calculation that is based at least in part on a number of defective pixels on a display device, a number of operational dials, a number of operational rollers, a number of operational leavers, and/or a number of operational buttons on at least the first portion of the physical product. For example, user interface 310 can render an image that includes the first-disposal-mode identifier. For example, the first-disposal-mode-identifier could include instructions for disposing of product 102 according, for example a recycling mode, e.g., the instructions could include text, audio, graphics, etc., that describe a way to recycle product 102 such as text that states “to recycle product 102 you may place it in a blue recycling bin.”

Quantification adjustment table 242 in this example can include information associated with a device-readable identifier for product 102 that maps a number of defective pixels on a display device, a number of operational dials, a number of operational rollers, a number of operational leavers, and/or a number of operational buttons on product 102 such as a mp3 player with tactile keys, an LCD display, etc., to adjustment-quantifications, which can be used to influence a calculation to determine whether to display the first potential-ecological-impact quantification or the second potential-ecological-impact quantification.

In a specific example, a user may input information indicative of the number of nonfunctional buttons into device 302 via user interface 310 and device 302 can send the number of nonfunctional buttons, a device-readable identifier for the mp3 player, etc. to LCM 118. LCM 118 can receive the message and use the device-readable identifier to look up disposal-mode-identifiers for the mp3 player and associated potential-ecological-impact quantifications for the disposal modes. LCM 118 could also search quantification adjustment table 242 for adjustment quantifications to use to adjust potential-ecological-impact quantifications.

In this example, LCM 118 could locate an adjustment-quantification and factor the adjustment-quantification and the potential-ecological-impact quantification into a calculation to obtain an adjustment-potential-ecological-impact quantification associated with reselling the mp3 player and compare the adjusted-potential-ecological-impact quantification for reselling the mp3 player to, for example, a potential-ecological-impact quantification for recycling the mp3 player. In this example LCM 118 can determine that the potential-ecological-impact quantification for recycling the mp3 player is lower than the adjusted-potential-ecological-impact quantification for reselling the mp3 player; and select the disposal mode that has the lower ecological-impact quantification, e.g., the recycling disposal mode; and send a message including the disposal-mode-identifier for recycling the mp3 player to device 302. Device 302 can receive the message and cause user interface 310 to display the disposal-mode-identifier for recycling the mp3 player.

Operation 1510 shows displaying the first-disposal-mode identifier responsive to a calculation that is based at least in part on an output from an automobile odometer. For example, in an embodiment, user interface 310 can render an image that includes the first-disposal-mode identifier. For example, the first-disposal-mode-identifier could include instructions for disposing of product 102 according, for example a recycle mode, e.g., the instructions could include text, audio, graphics, etc., that describe a way to recycle product 102 such as text that states “to recycle product 102 you may call this number and a service representative will collect product 102.”

Quantification adjustment table 242 in this example can include information associated with a device-readable identifier for product 102 that maps mileage to adjustment-quantifications, which can be used to influence a calculation to determine whether to display the first potential-ecological-impact quantification or the second potential-ecological-impact quantification.

In this example, user may input information indicative of the mileage into device 302 via user interface 310 and device 302 can send the mileage, a device-readable identifier for car, etc. to LCM 118. LCM 118 can receive the message and use the device-readable identifier to look up disposal-mode-identifiers for the car and associated potential-ecological-impact quantifications for the disposal modes. LCM 118 could also search quantification adjustment table 242 for adjustment quantifications to use to adjust potential-ecological-impact quantifications.

In this example, LCM 118 could locate an adjustment-quantification and factor the adjustment-quantification and the potential-ecological-impact quantification into a calculation to obtain an adjustment-potential-ecological-impact quantification associated with reselling the car and compare the adjusted-potential-ecological-impact quantification for reselling the car to, for example, a potential-ecological-impact quantification for recycling the car. In this example LCM 118 can determine that the potential-ecological-impact quantification for recycling the car is lower than the adjusted-potential-ecological-impact quantification for reselling the car; and select the disposal mode that has the lower ecological-impact quantification, e.g., the recycling disposal mode; and send a message including the disposal-mode-identifier for recycling the car to device 302. Device 302 can receive the message and cause user interface 310 to display the disposal-mode-identifier for recycling the car.

Referring now to operation 1512, it shows displaying the first-disposal-mode identifier responsive to a calculation that is based at least in part on a number of defective memory sectors in at least the first portion of the physical product. For example, user interface 310 can render an image that includes the first-disposal-mode-identifier.

In this example, user interface 310 could have rendered the first disposal mode identifier in response to the output from status determination module 360, the first-potential-ecological-impact quantification associated with product 102 and the second-potential-ecological-impact quantification associated with product 102. Product 102 in this example could be a computing device such as a tablet pc with status determination module 360, which be a component of an operating system or a hardware integrated circuit that monitors memory sectors. In this example, status determination module 360 can determine whether the memory sectors are bad, i.e., whether they can store a charge and communicate such information to device 302.

Device 302 can receive information from status determination module 360 via, for example, network 100 in response to a status information request. Device 302 can then generate a message that includes the output from status determination module 360, a device-readable identifier for the tablet pc, etc., and send the message to LCM 118 via network 100. LCM 118 can be configured to use the device-readable indicator for the tablet pc to search for potential-ecological-impact quantifications for disposing of product 102 in disposal mode quantification table 220. In this example, LCM 118 could obtain at least two potential-ecological-impact quantifications associated with at least two disposal-modes for product 102.

In addition to at least two potential-ecological-impact quantifications associated with disposal modes for product 102, LCM 118 can access quantification adjustment table 242 to search for one or more adjustment-quantifications, which can be used to influence the selection of a disposal-mode-identifier to recommend. In this exemplary embodiment, quantification adjustment table 242 can contain a table for product 102 which maps information such as the percentage of defective memory sectors to different adjustment-quantifications. After LCM 118 obtains a status-value and at least two potential-ecological-impact quantifications associated with at least two disposal-mode-identifiers for product 102, LCM 118 can be configured to use the adjustment quantification(s) to reduce the likelihood that a resell disposal mode is recommended. In this example, LCM 118 can determine that the first potential-ecological-impact quantification, e.g., a quantification associate with recycling, is less than the second potential-ecological-impact quantification after it has been adjusted and send one or more packets the first-disposal-mode identifier to device 302. LCM 340 can receive the first-disposal-mode identifier and cause a bitmap that includes the first-disposal-mode identifier to be rendered by user interface 310.

Operation 1514 shows displaying the first-disposal-mode identifier responsive to a calculation that is based at least in part on a price for at least the first portion of the physical product on a market. For example, user interface 310 can render an image that includes the first-disposal-mode identifier. In this example, user interface 310 can render the first disposal mode identifier in response to a calculation that takes into account the price of product 102, the first-potential-ecological-impact quantification associated with product 102, and the second-potential-ecological-impact quantification associated with product 102. In this example embodiment, status information such as the price of product, e.g., a mobile phone, mp3 player, etc., obtained from Amazon.com®, E-Bay®, etc., can be received from product price 244. In this example, price information is used to infer how desirable product 102 still is. For example, quantification adjustment table 242 can map the price of a product to adjustment quantifications that can be used to reduce the likelihood that a resell disposal-mode-indicator is selected.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1. A system, comprising:
a physical product associated with a device-readable indicator, the device-readable indicator associated with a first potential-ecological-impact quantification and with a first-disposal-mode identifier describing a first mode of disposing of at least a first portion of the physical product.

2.-70. (canceled)

71. A computer implemented method, comprising:
receiving a device-readable indicator associated with at least a first portion of a physical product, the device-readable indicator associated with a first potential-ecological-impact quantification and a first-disposal mode identifier describing a first mode of disposing of at least the first portion of the physical product; and
displaying information that is at least based on the first potential-ecological-impact quantification.

72.-138. (canceled)

139. A computer-readable storage medium including executable instructions, the computer-readable storage medium, comprising:
instructions for receiving a device-readable indicator associated with at least a first portion of a physical product, the device-readable indicator associated with a first potential-ecological-impact quantification and a first-disposal mode identifier describing a first mode of disposing of at least the first portion of the physical product; and
instructions for displaying information that is at least based on the first potential-ecological-impact quantification.

140.-206. (canceled)

207. A system, comprising:
means for receiving a device-readable indicator associated with at least a first portion of a physical product, the device-readable indicator associated with a first potential-ecological-impact quantification and a first-disposal mode identifier describing a first mode of disposing of at least the first portion of the physical product; and
means for displaying information that is at least based on the first potential-ecological-impact quantification.

208.-274. (canceled)

275. A computer implemented method, comprising:
associating a physical product with a user account in response to receiving a device-readable indicator for the physical product; and
adjusting an ecological-impact score associated with the user account based on a potential-ecological-impact quantification associated with the physical product.

276.-331. (canceled)

332. A system, comprising:
circuitry for associating a physical product with a user account in response to receiving a device-readable indicator for the physical product; and
circuitry for adjusting an ecological-impact score associated with the user account based on a potential-ecological-impact quantification associated with the physical product.

333.-387. (canceled)

388. A system, comprising:
means for associating a physical product with a user account in response to receiving a device-readable indicator for the physical product; and
means for adjusting an ecological-impact score associated with the user account based on a potential-ecological-impact quantification associated with the physical product.

389.-443. (canceled)

444. A computer-readable storage medium, comprising:
instructions for associating a physical product with a user account in response to receiving a device-readable indicator for the physical product; and
instructions for adjusting an ecological-impact score associated with the user account based on a potential-ecological-impact quantification associated with the physical product.

445.-499. (canceled)
